(19) United States
(12) Patent Application Publication
(10) Pub. No.: US 2012/0264571 A1
(43) Pub. Date: Oct. 18, 2012

(54) CONSTRUCTION SYSTEM WITH INFLATED MEMBERS

(75) Inventors: Mark W. Publicover, Saratoga, CA (US); Donald Strasser, Los Gatos, CA (US); Jon Hylbert, Los Gatos, CA (US)

(73) Assignee: Mark W. Publicover

(21) Appl. No.: 13/252,174

(22) Filed: Oct. 3, 2011

Related U.S. Application Data
(63) Continuation of application No. 11/949,689, filed on Dec. 3, 2007, now abandoned.
Application No. 11/949,689 is a continuation-in-part of application No. 11/733,183, filed on Apr. 9, 2007, now abandoned.
(60) Provisional application No. 60/790,226, filed on Apr. 7, 2006.

(51) Int. Cl. A63G 31/00; F16B 1/00; F16B 17/00

(52) U.S. Cl. 482/35; 403/345; 403/376; 403/220

(57) ABSTRACT

Self-supporting structures are assembled from hollow construction members, particularly inflatable balls made of a durable resilient material.

### CROSS REFERENCE TO RELATED APPLICATIONS

This is a continuation of application Ser. No. 11/949,689, filed Dec. 3, 2007, which is a continuation-in-part of application Ser. No. 11/733,183, filed Apr. 9, 2007, which claims the benefit of U.S. Provisional Application No. 60/790,226, filed Apr. 7, 2006, all of which prior applications are incorporated herein in their entirety.

### BACKGROUND AND SUMMARY

The present invention concerns structures that are formed from multiple connected hollow structural elements.

Certain types of structure, particularly backyard play structure and floating structure such as rafts and docks, are advantageously formed from multiple construction elements joined together at their surfaces.

### BRIEF DESCRIPTION OF THE DRAWINGS

FIG. 1 is a schematic diagram of a body centered cubic structure.

FIG. 2 is a schematic diagram of a climb-on raft that has hexagonal close-packed structure.

FIG. 3 is a schematic diagram of a geodesic play-in and climb-on structure.

FIG. 4 is a schematic diagram of a hexagonal close-packed structure.

FIG. 5 is an oblique schematic view of a playhouse.

FIG. 6 is a perspective schematic view of a pyramid of hexagonal close-packed structure.

FIG. 7 is a perspective schematic view showing the assembly of FIG. 6 supported on the bed of a trampoline.

FIG. 8 is a perspective schematic view showing a single-layer floating raft assembly.

FIGS. 9-12 are schematic views diagrams showing various structure arrangements.

FIG. 13A is a perspective schematic view showing a two-headed connector element.

FIG. 13B is a vertical sectional view of the connector of FIG. 13A.

FIG. 13C is a perspective schematic view showing a removal tool for use with the connector of FIG. 13A and FIG. 13B.

FIG. 14 is an exploded perspective view showing a connector system having a pocket element formed from two pieces molded.

FIG. 15 is a perspective view of the connector system of FIG. 14.

FIG. 16A is a perspective schematic view showing a coupler of a “finger cuff” connector system.

FIG. 16B is an exploded vertical sectional view showing a connector system incorporating the coupler of FIG. 16A.

FIG. 16C is a vertical sectional view of the connector system of FIG. 16B.

FIG. 16D is a perspective schematic view showing a tab of the connector system of FIG. 16B.

FIG. 16E is a top plan view of the tab of FIG. 16D.

FIG. 16F is an elevational side view of the tab of FIG. 16D.

FIG. 17A is a perspective schematic view showing a cam lock connector, with a portion broken away to show internal structure.

FIG. 17B is a horizontal sectional view showing the connector of FIG. 17A joining two two balls that have projecting rods.

FIG. 17C is a vertical sectional view taken along line 17C-17C of FIG. 17B.

FIG. 18A is a perspective schematic view showing a ball contained within a fabric ball cover.

FIG. 18B is a perspective schematic view showing a ball caged within a harness.

FIG. 18C is a vertical sectional view of a connector system mounted on a ball cover or harness.

FIG. 18D is a front plan view of a pocket element of the connector system of FIG. 18C.

FIG. 19A is a perspective schematic view showing a first step in assembly of a ball with a fabric ball cover.

FIG. 19B is a perspective schematic view showing a second step in assembly of a ball with a fabric ball cover.

FIG. 20A is a partial perspective view of strap harness systems of two joined balls.

FIG. 20B is a perspective view of a ball encaged by a strap harness system.

FIG. 21A is a perspective view of panel segment of an enclosure for a ball.

FIG. 21B is a perspective view of a ball enclosure formed from panel segments of FIG. 21A.

FIG. 22 is a perspective view of a strap harness system for encaging a ball.

FIG. 23A is a partial perspective view of a strap harness system showing a cable tie device for binding straps together.

FIG. 23B is a partial perspective view of a strap harness system showing a webbing adjustment buckle device for binding straps together.

FIG. 23C is a partial perspective view of a strap harness system showing a cord lock device for binding straps together.

FIG. 23D is a partial perspective view of a strap harness system showing a cord lock device for binding straps together.

FIG. 23E is a partial perspective view of a strap harness system showing a webbing loop system for binding straps together.

FIG. 23F is a perspective view of a ball encaged by a ball cover and the strap harness system of FIG. 23E.

FIG. 23G is a partial perspective view of a cable clamp device for binding straps of a strap harness system together.

FIG. 24A is a perspective view of a strap device for binding straps of a strap harness system together.

FIG. 24B a partial perspective view of a strap harness system including the strap device of FIG. 24A.

FIG. 24C is a perspective view of a loop and knob device for binding straps of a strap harness system together.

FIG. 24D a partial perspective view of a strap harness system including the loop and knob device of FIG. 24C.

FIG. 25 illustrates a strap harness system connection utilizing an elastic strap.

FIG. 26 shows a strap harness system connection using an elastic strap.

FIG. 27 illustrates two strap harness system connectors.

FIGS. 28-29 show a connector that can be used in place of the cam lock connector shown in FIG. 19.

FIG. 30 shows a connector system which uses ordinary inflated members and two different types of connector bases that are secured together with straps.

FIGS. 31 and 32 show two different types of connectors to be used with inflated members having molded loop features 3108 at each of the connection points.

FIG. 33 illustrates two connection systems of multi chamber inflated members.

FIG. 34 shows an alternative technique for construction with multiple balls.

FIG. 35 shows a structure formed with multiple balls.

FIG. 36 shows constructions for supporting either square or round trampolines on structure made of inflated balls and hollow construction elements.

FIG. 37 illustrates a system composed of two sizes of inflated balls, and rigid or semi-rigid cylindrical connectors.

FIG. 38 illustrates a system of hollow construction members using inflated balls and inflated toroidal members which are connected using straps.

FIG. 39 shows a structure formed from arrays of inflated balls and inflated tubular members that are connected using “carabiner” style gated connectors.

FIG. 40 shows a perspective view of a ball having eye connectors.

FIG. 41A is a front plan view of a first ball connector suitable for use with the ball of FIG. 40.

FIG. 41B is a front plan view of a second ball connector suitable for use with the ball of FIG. 40.

FIG. 41C is a front plan view of a third ball connector suitable for use with the ball of FIG. 40.

FIG. 42A is a perspective view of a fourth ball connector suitable for use with the ball of FIG. 40.

FIG. 42B is a perspective view of a fifth ball connector suitable for use with the ball of FIG. 40.

FIG. 42C is a perspective view of a sixth ball connector suitable for use with the ball of FIG. 40.

FIG. 43A is a perspective view of four the balls of FIG. 40 connected together.

FIG. 43B is a perspective view of five of the balls of FIG. 40 connected together.

### DETAILED DESCRIPTION

Structures can be formed from a variety of materials and using any of several types of connectors. A particular member for use as the basic building block is a hollow ball that is inflatable, resilient such that it would bounce, and made of a durable material much like a hopping ball used by children or an exercise ball used by adults. By spacing multiple connectors around each of several hollow balls, a multitude of different structures can be built. Structures build from such members are particularly well suited for back-yard play structures and floating structures such as rafts and floating docks.

Balls of uniform, generally spherical shape are the most versatile building elements as they can be joined by connectors at various appropriate locations on their surfaces. Such balls advantageously will be at least one foot in diameter. But ball members can be of different sizes and shapes, such as generally rectangular or generally square block shapes and such as shapes having one or more generally triangular side such as generally pyramidal shapes.

Ball members can be made from any number of materials depending on the engineering specifications and expected use of the structure being built. For instance, building balls can be made out of foam, plastic, rubber, metal, and other type of materials or combinations of materials and can be partially or completely filled with gas, liquid, small balls, or many other materials to change the performance dynamics of the ball and the structure into which it is incorporated. Members made of a rotomolded thermoplastic material, particularly polyvinyl chloride, are particularly well suited to provide structures of high rigidity.

In some configurations, members of other shapes, such as cylinders and toroids, may be used in conjunction with the balls for purposes including but not limited to adding stability, adding rigidity, and filling gaps between the balls of an array.

The construction system is designed so that the balls can be easily connected to each other for the purpose of building a multitude of structures of different shapes and sizes for play, commercial, or industrial use, including building-like structures that define an interior region that is hollow and of sufficient size to receive a person.

Connecting mechanisms enable the balls to be easily connected to and disconnected from each other and can be constructed to provide a multitude of connection points on members so that an almost limitless number of structures can be created using the basic ball with its connection system.

The connections can be designed to enable other connectors to be affixed to a point on a ball or a harness or cover unit surrounding a ball. For instance, an inverted cap or a short rod connector can be attached to or part of the ball unit. This protruding connector can then be used to connect poles and the like to one ball or a multi-ball structure created by systematically stacking or connecting the balls adjacently. Protruding connectors can be used to snap the legs of a table or platform onto the top of several balls that are part of a raft of adjacently connected balls floating in the water or poles can be slipped into such connectors and used to form a tent like structure over the top of the raft or to build a play structure or swing set on top of the ball raft or to install pole structures that are incorporated into a multi-ball structure so that the balls can be spaced apart from each other and still be somewhat rigidly connected together through the pole structure. Such can be used to build a raft made with a square pole frame with fabric stretched over the frame with ball units positioned below each corner of the frame. Multiple configurations of numerous shapes and sizes can be built using such a system. The ball units can be attached together in a string and the ends attached to form a circle, then a piece of impermeable fabric large enough to span surface area between the balls can be connected to the tops of the balls filled with water to form a pool.

As mentioned above, some of the balls of a structure can be partially or entirely filled with water or some other heavier-than-air substance. This can be useful to stabilize the structure. Such filled balls are particularly useful to serve as ballast for a floating structure. To enhance stability, such filled balls should be located at or near the bottom of a structure to lower the center of gravity of the structure as a whole.

The ball units can be stacked to form a pyramid many layers in height or walls can be built to create a house-like structure. Various play or athletic structures, such as climbing walls, may be supported by a structure constructed with such ball units. The possibilities for building various structures by utilizing these simple ball units with accessory poles and panels are practically endless. Particular structures, connectors and construction techniques can be seen with reference to the accompanying drawings.

In certain structures, it is advantageous for at least some of the members to be of a first load capacity and at least some other of the members to be of a second load capacity that is different than the first. In particular, because it is efficient to use members of the lowest appropriate weight, but light-weight hollow members are subject to crushing, the best arrangement in some structures is for at least some of the members at the base of the structure have a greater net load capacity than members at a higher elevation in the structure. This can be accomplished in several ways. A structure may have at least some members at the base of the structure with walls that are thicker than the walls of members at a higher elevation in the structure. And/or a structure may have at least some members at the base of the structure with walls that are more rigid than the walls of members at a higher elevation in the structure.

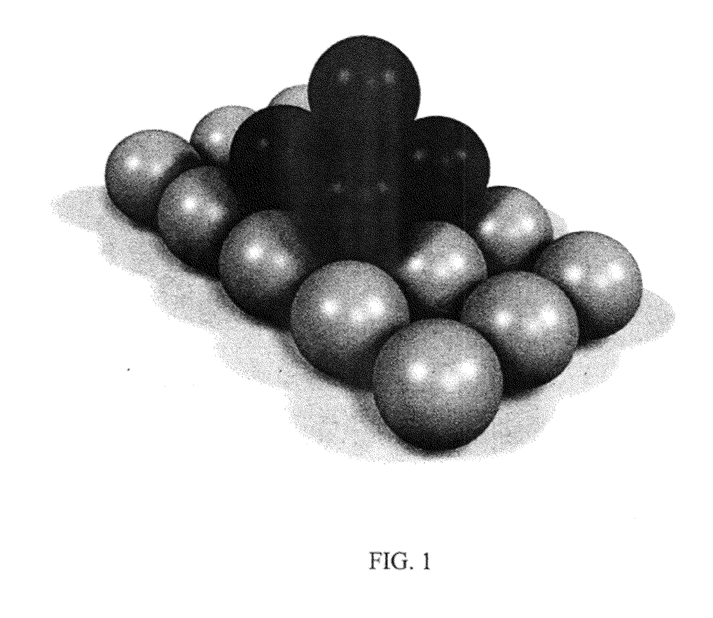

FIG. 1 illustrates how balls can be arranged to form a climb-on raft using a body centered cubic structure. In the illustrated raft, twenty total balls are arranged in an array with fifteen on the base layer, four on the second layer, and one on the third layer.

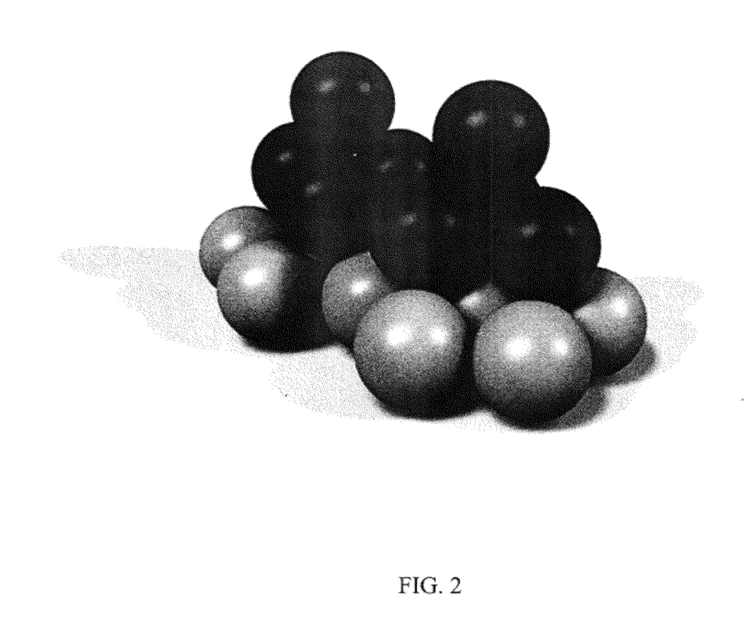

FIG. 2 shows another arrangement for a climb-on raft using hexagonal close-packed structure having two distinct peaks. Twenty total balls are used, with twelve on the base level, six on the second level, and two on the third level.

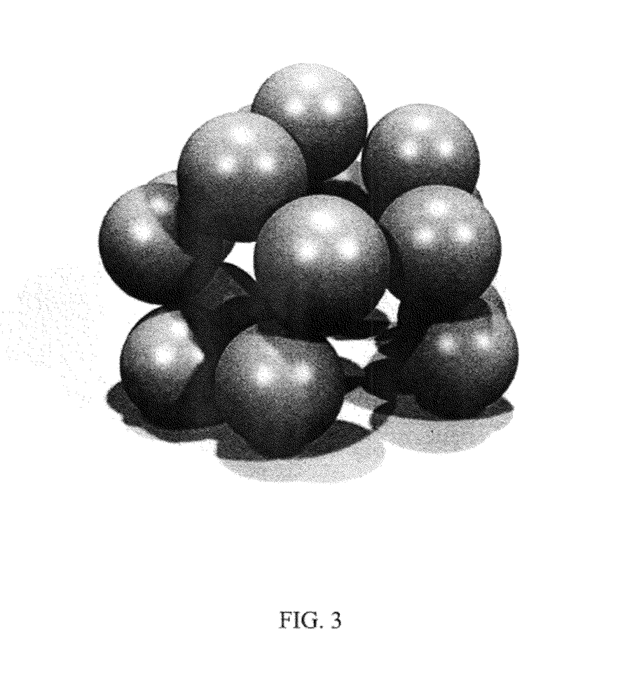

FIG. 3 shows an arrangement for a geodesic play-in and climb-on structure constructed from members arranged to form interlocking polygons such that at least a portion of the structure has the shape of a dome. Sixteen balls are joined at connection points so that groups of five describe a plane, and together the planes form the faces of a dodecahedron with the exception of its lower face.

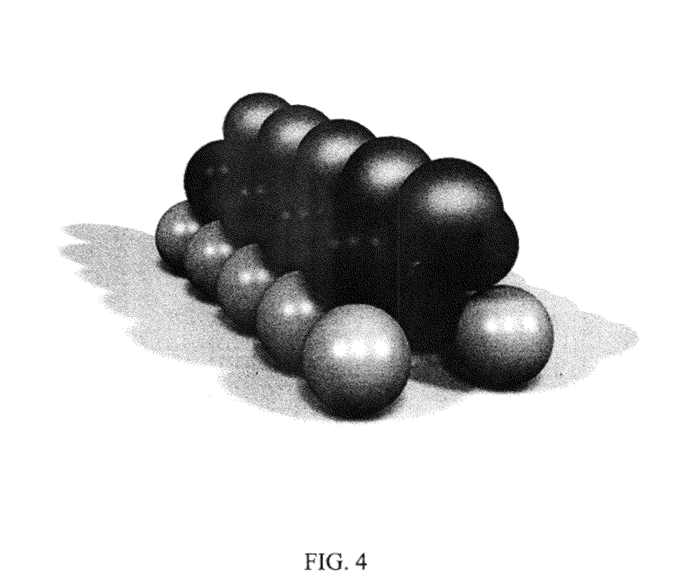

FIG. 4 shows an arrangement for a crawl-through or climb-on tunnel constructed with a hexagonal close-packed structure using a total of twenty-three balls. Ten balls are used on the base layer, eight are used on the second layer, and five are used on the top layer.

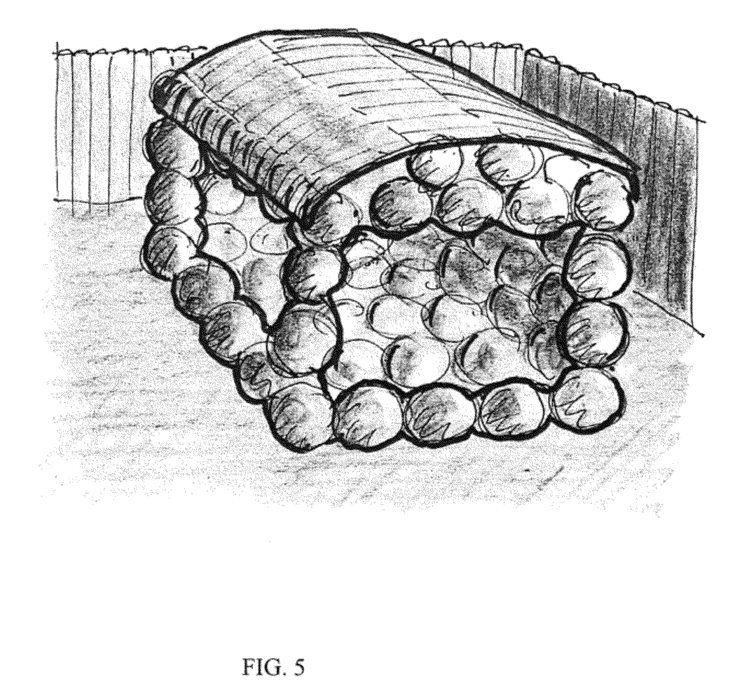

FIG. 5 shows a playhouse constructed with front and side openings, a floor composed of a layer of balls, and a tarp forming a roof. The number of balls used to form the sides and floor may be increased or decreased to modify the size of the playhouse.

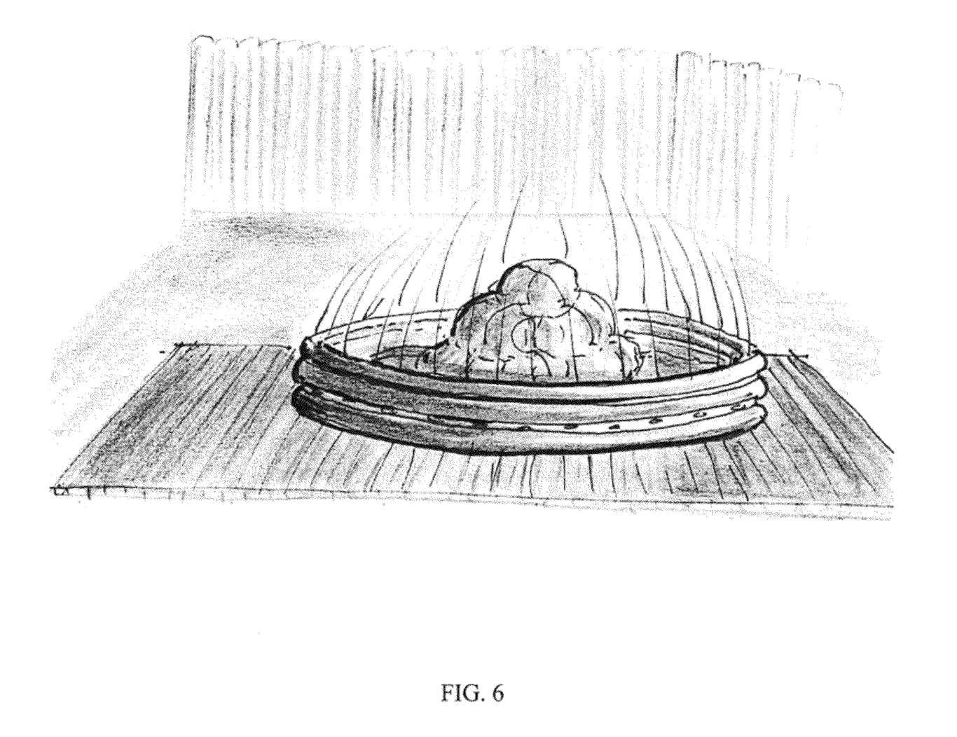

FIG. 6 shows a pyramid of hexagonal close-packed structure, made of eleven balls, in an inflatable swimming pool. Running water may be supplied to the device, providing a pressurized spray from jets either arranged around the structure or from the top of the structure. These jets spray water on the structure, to provide a slippery surface and increase climbing difficulty.

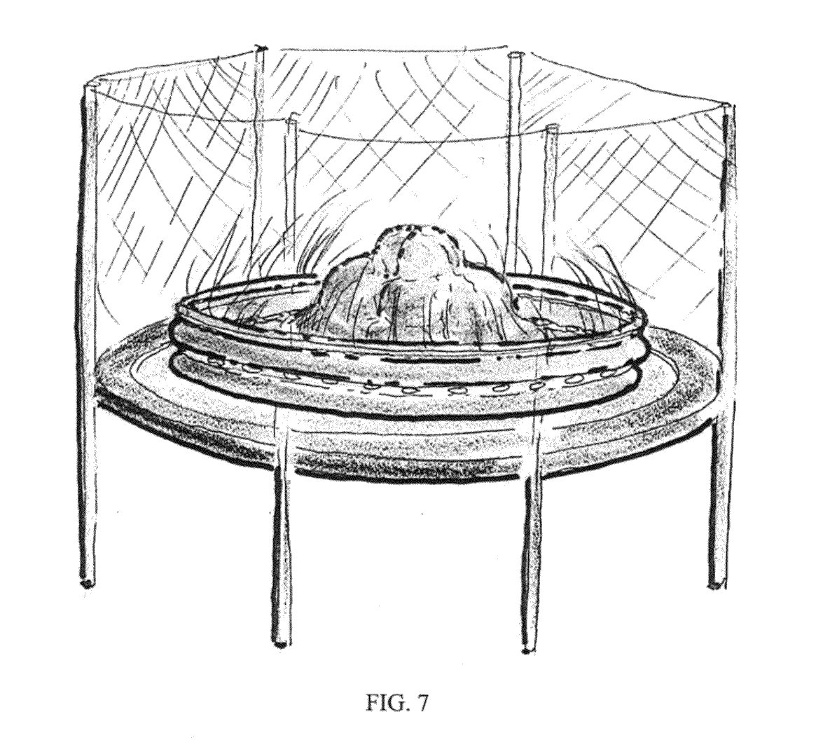

FIG. 7 illustrates the assembly of FIG. 6 supported on the bed of a trampoline and surrounded by a safety enclosure.

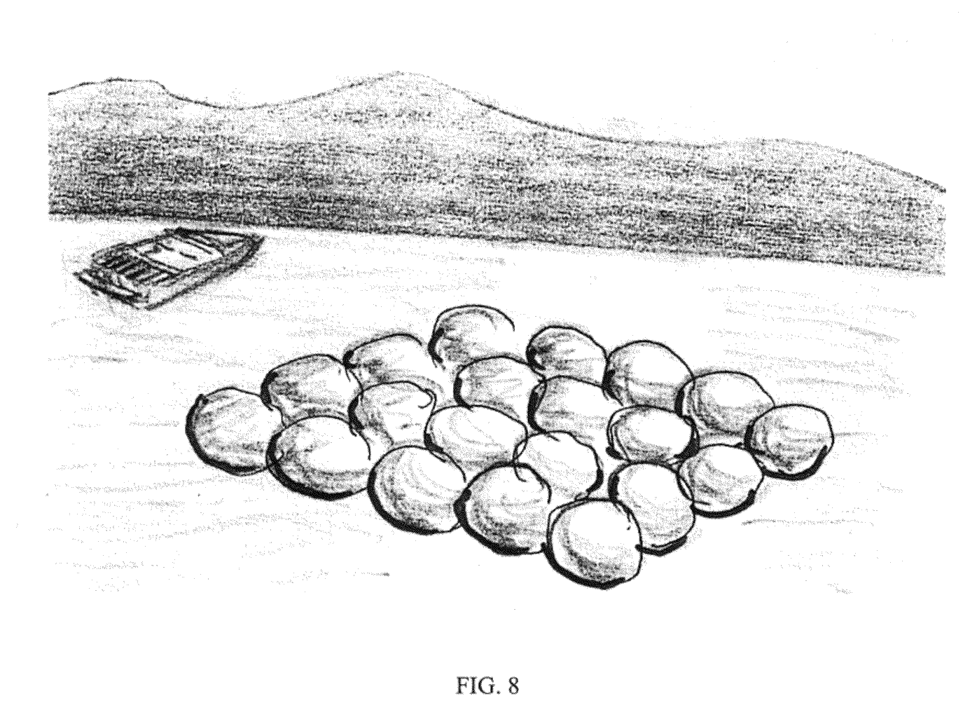

FIG. 8 illustrates a single-layer floating raft assembly suitable for use in open water. At least some of the members from which the raft assembly is constructed are sufficiently buoyant that the structure can float in water. Accessories, such as cooler chests, slides, ladders, stairs, hammocks, and seats, may be used in conjunction with such raft assemblies or with other structures described herein. Sails, paddles, oars and rowlocks and/or motors, such as motor mounts and associated outboard motors, may be provided on a raft assembly for propulsion.

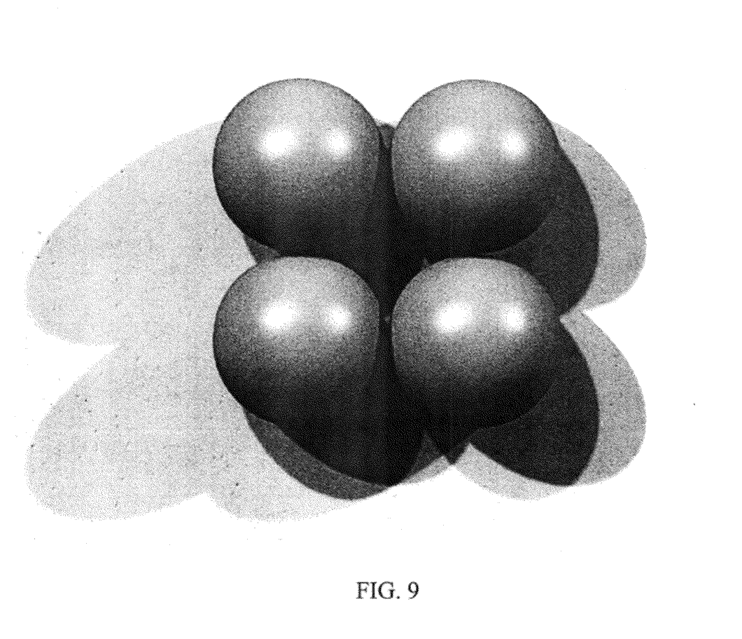

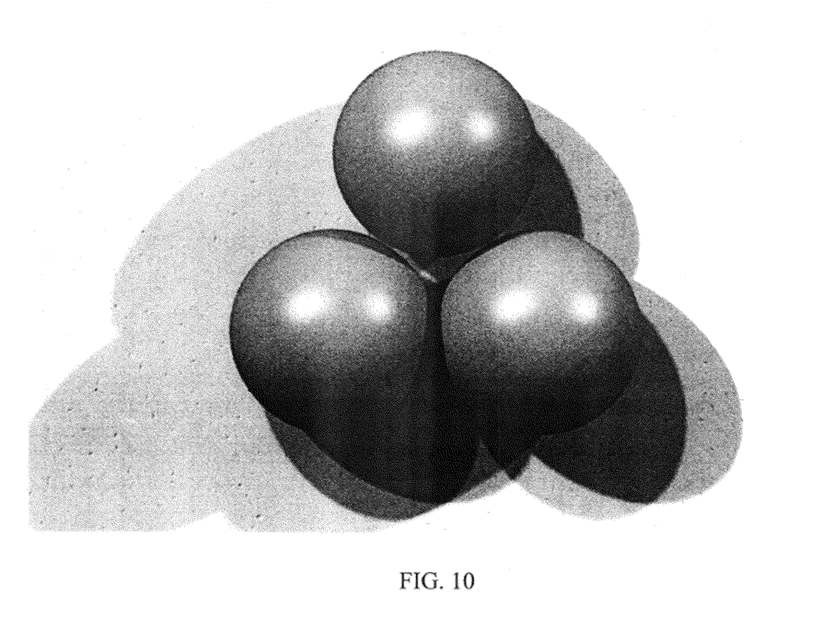

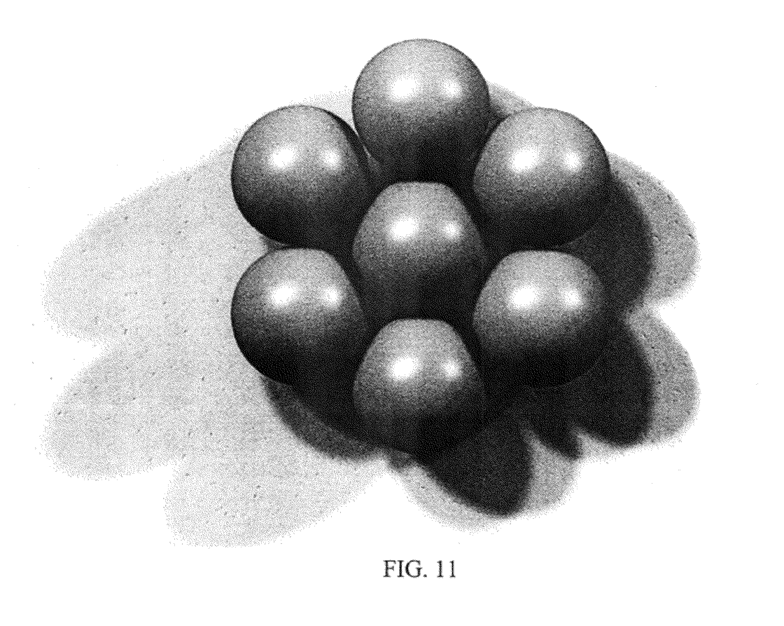

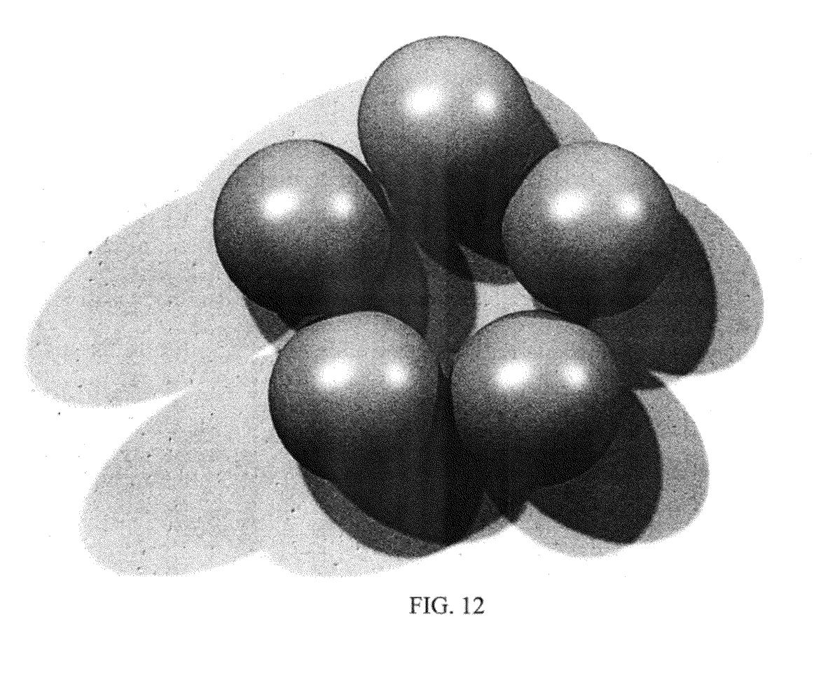

FIGS. 9-12 show different structure arrangements where all the balls are generally spherical and of uniform diameter. In these arrangements ball center to center distances are always equal, assuming the same size balls are used in a structure. In particular, FIG. 9 shows the base of a cubic arrangement with all connections at 90 degrees. FIG. 10 shows a triangular arrangement with connections at angles of 60 degrees in a plane. FIG. 11 shows a seven-ball plane with connections at 60 degree as in a triangular arrangement. FIG. 12 illustrates a ring structure, in particular a planar arrangement of five balls with connections at 108 degree angles such that the ring has an open center.

The locations of the connectors on the balls is arranged to provide for maximum flexibility for construction. Optimal connector locations for various types of construction techniques with spherical balls are as noted in Table I.

TABLE I
Connector Positioning

| | | Req. in | | | |
|---|---|---|---|---|---|
| | Connections | addition | Lattitude | | Longitude |
| Geometry | Required | to Cubic | (Deg) | | (Deg) |
| Cubic | 6 | N/A | 90 | N | 0 E |
| (Hexahedron) | | | | | |
| | | | 90 | S | 0 E |
| | | | 0 | N | 0 E, 90 E, |
| | | | | | 180 E, 270 W |
| Body Centered | 14 | 8 | 90 | N | 0 E |
| Cubic (BCC) | | | | | |
| | | | 90 | S | 0 E |
| | | | 0 | N | 0 E, 90 E, |
| | | | | | 180 E, 270 W |
| | | | 45 | N | 45 E, 135 E, |
| | | | | | 135 W, 45 W |
| | | | 45 | S | 45 E, 135 E, |
| | | | | | 135 W, 45 W |
| Face Centered | 12 | 10 | 0 | N | 0 E, 60 E, |
| Cubic (FCC) | | | | | 120 E, 180 E, |
| only | | | | | 120 W, 60 W |
| | | | 54.3 | N | 30 E, 150 E, |
| | | | | | 90 W |
| | | | 54.3 | S | 30 E, 150 E, |
| | | | | | 90 W |
| FCC & | 18 | 16 | 0 | N | 0 E, 60 E, |
| Hexagonal | | | | | 120 E, 180 E, |
| Close Packed | | | | | 120 W, 60 W |
| (HCP) | | | | | |
| | | | 54.3 | N | 30 E, 90 E, |
| | | | | | 150 E, 150 W, |
| | | | | | 90 W, 30 W |
| | | | 54.3 | S | 30 E, 90 E, |
| | | | | | 150 E, 150 W, |
| | | | | | 90 W, 30 W |
| (Dodecahedron) | 4 | 3 | 0 | N | 0 E, 108 E |
| | | | 58.3 | N | 126 W |
| | | | 58.3 | S | 126 W |
| Universal | 33 | 27 | 0 | N | 0 E, 60 E, 90 E, |
| (all of above) | | | | | 108 E, 120 E, |
| | | | | | 180 E, 270 W, |
| | | | | | 120 W, 60 W |
| | | | 45 | N | 45 E, 135 E, |
| | | | | | 135 W, 45 W |
| | | | 45 | S | 45 E, 135 E, |
| | | | | | 135 W, 45 W |
| | | | 54.3 | N | 30 E, 90 E, |
| | | | | | 150 E, 150 W, |
| | | | | | 90 W, 30 W |
| | | | 54.3 | S | 30 E, 90 E, |
| | | | | | 150 E, 150 W, |
| | | | | | 90 W, 30 W |
| | | | 58.3 | N | 126 W |
| | | | 58.3 | S | 126 W |
| | | | 90 | N | 0 E |
| | | | 90 | S | 0 E |

As will be appreciated from the following discussion, there are several ways in which balls or other structural elements can be joined to provide a structure that is self supporting. The structural elements should be joined together in such a manner that they cannot be separated during routine use of the structure for its intended purpose. For structures that are intended to support persons or equipment, the connections must be sufficiently strong to prevent the elements from disconnecting as a result of anticipated loading and impact forces. Connection systems described herein include snap bone couplers, cam lock couplers, rubber ‘button’ bone couplers, expanding couplers, “finger cuff” couplers, and cam couplers.

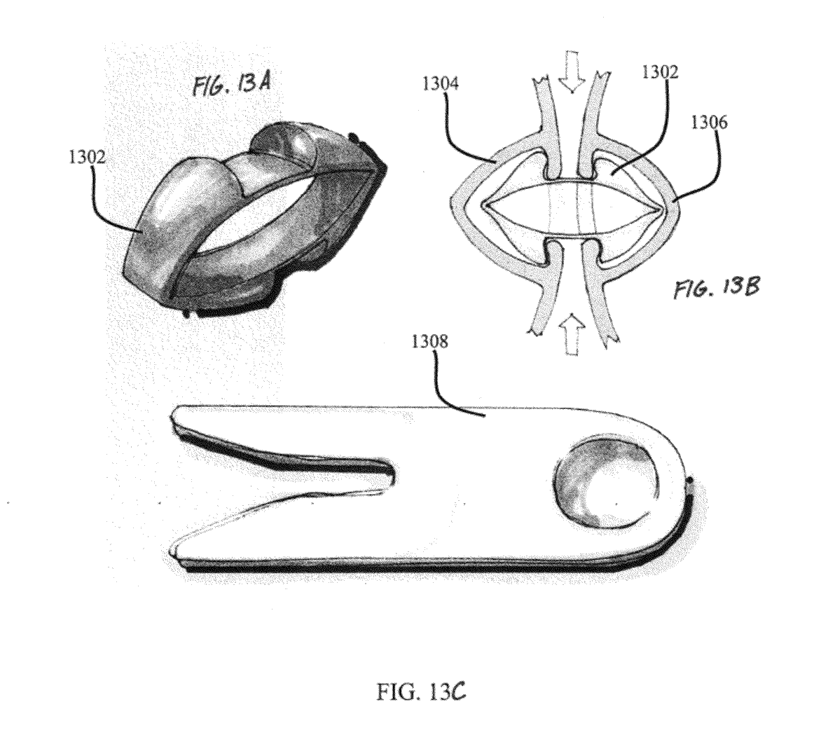

FIGS. 13A-C show a system employing a two-headed connector element. Balls have molded pockets 1304 and 1306 that will accept the illustrated injection-molded snap bone 1302. The heads at the ends of the bone collapse when being inserted and then spring open or pop out when entering the larger cavity at the base of the socket. A removal tool 1308 is pictured that can be used for installing and removing the coupler. Alternatively, a built-in mechanism may be provided for collapsing the bone heads for easy removal.

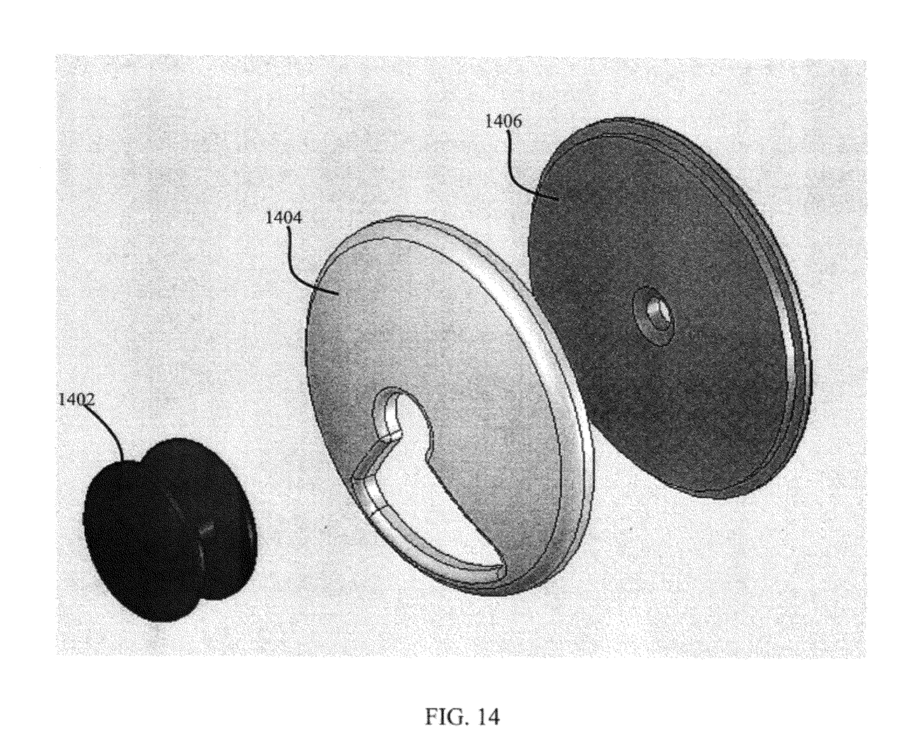

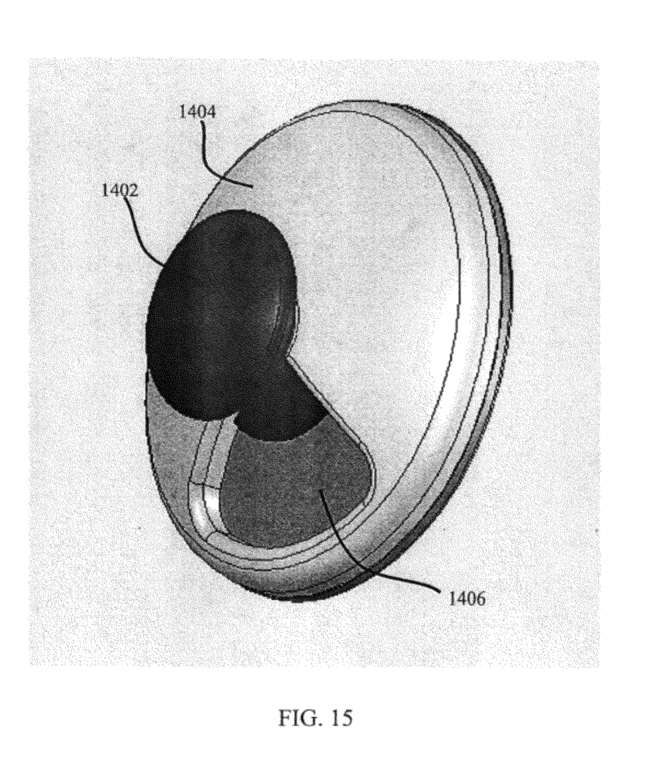

FIGS. 14-15 show a system wherein a pocket is formed from two pieces of injection molded plastic 1404, 1406, each about 1.5 inches in diameter. Connectors, elements, or unions 1402 each comprise two buttons joined by a neck or column. The buttons and center column are dimensioned such that when the buttons are inserted in facing pockets, the center column is under tension to hold the balls tightly together. FIG. 14 is an exploded view of all the parts, and FIG. 15 shows the parts joined as would be the case when the balls are connected. A countersunk hole in the base member is provided to receive a plastic rivet (not shown). The plastic rivet is used to attach the member to a fabric ball cover or strap harness. Such a pocket can also be molded into a ball. In the preferred embodiment the front and back pocket parts are ultrasonically welded together, but other means may be used as well.

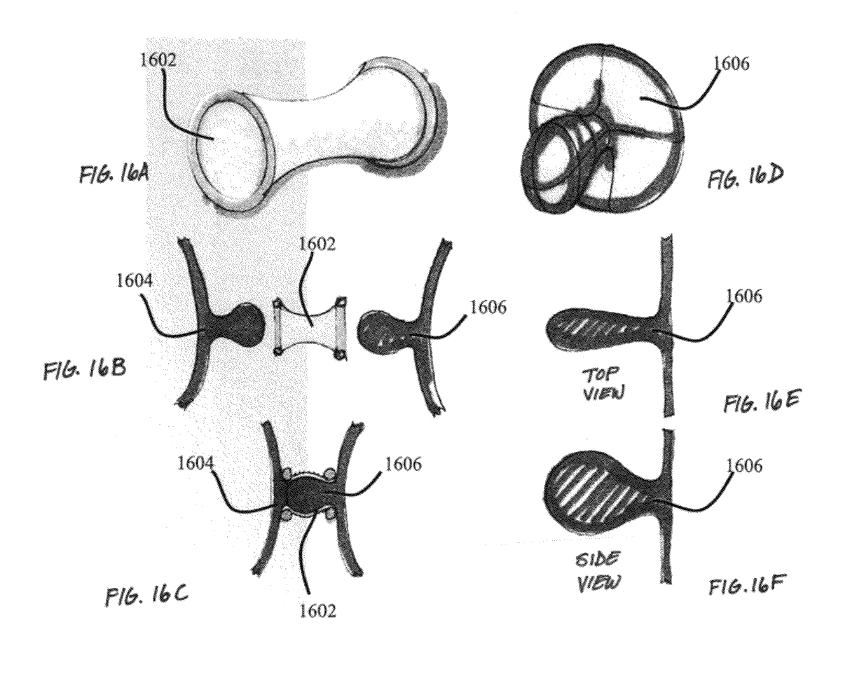

FIGS. 16A-F illustrate a “finger cuff” connector. A each of two balls have external solid molded tabs 1604, 1606 that protrude from the surface of the balls. Each tab is a rounded generally hemispherical shape such that two opposing tabs 1604, 1606 fit together to form a nearly spherical shape that can be contained within an expanded mesh coupler 1602. The center portion of coupler can be compressed to release the tabs.

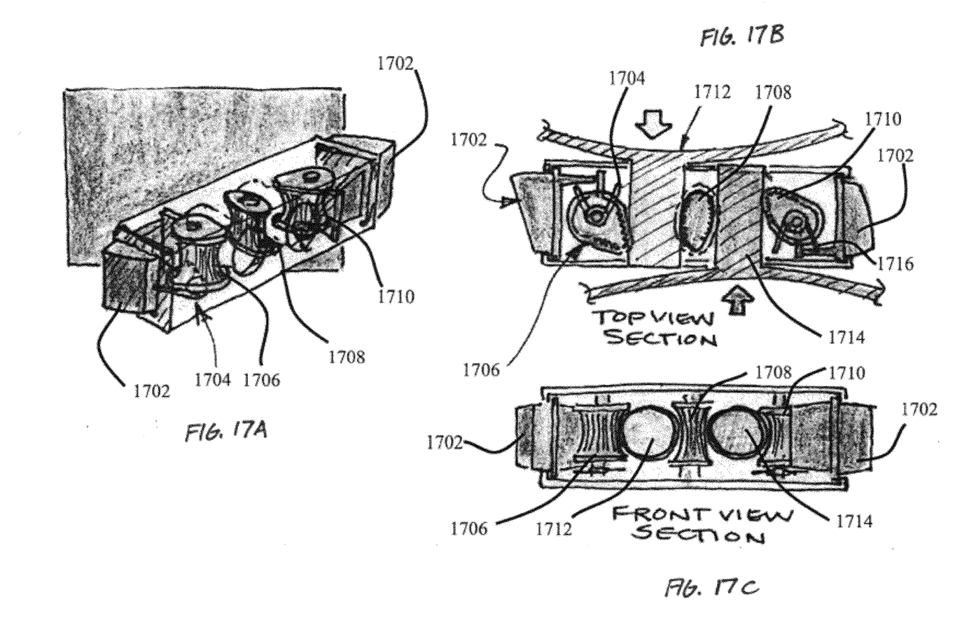

FIGS. 17A-C show a connector that can be used in a system with balls that have external solid rods 1712, 1714 that protrude from their surfaces. In the illustrated system, such rods are molded onto the surfaces of the ball members. The connector houses two spring-loaded cams 1706, 1710 with locking teeth. Each spring-loaded cam 1706, 1710 has a separate release button 1702 and is biased toward a locking position by a torsion spring 1704, 1716. A stationary center post with teeth 1708 provides an opposing grip for each cam to act against. A rod 1712, 1714 from one ball can be attached to or released from the connector independently of a rod of another attached ball. A release button 1702 can be pressed to overcome a torsion spring 1704, 1716 and thereby release an attached ball.

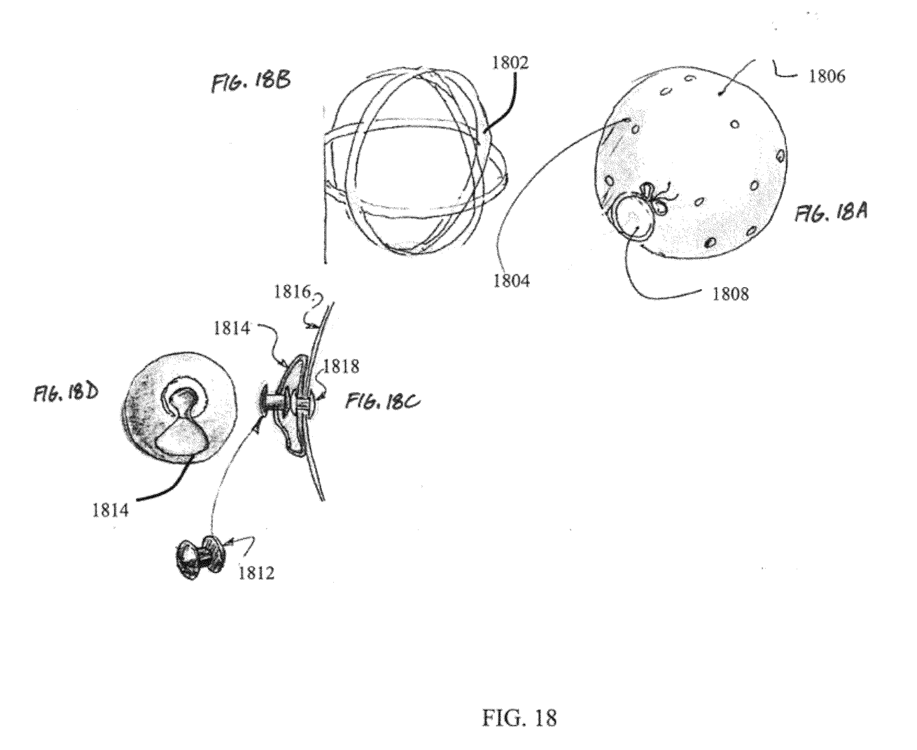

FIGS. 18A-C better illustrates how connectors can be provided on balls and other hollow members. Ordinary inflatable members may be used in either of two methods. The first method consists of surrounding a member with a fabric ball cover 1806 that has attached connector elements 1804. In the embodiment shown, connectors 1804 consist of body 1814 and a button element 1812. The body 1814 is connected to a harness 1802 or a fabric cover 1816 by a plastic rivet 1818.

Two methods are illustrated for providing a ball within the fabric cover 1816. In a first method, as shown in FIG. 18A, a ball cover 1806 has an opening 1808 which can be stretched so that a full-sized ball can be passed to the interior of the cover. The illustrated cover 1806 also has drawstrings that can be used to reduce the size of the opening and tighten the cover over the ball. The second method consists of placing a deflated ball into a cover 1806, and then inflating it. For this second method the cover can have an inflexible opening and no drawstring. Connection points may also be provided by surrounding the ball with a harness 1802 of straps having attached connector elements as shown in FIG. 18B.

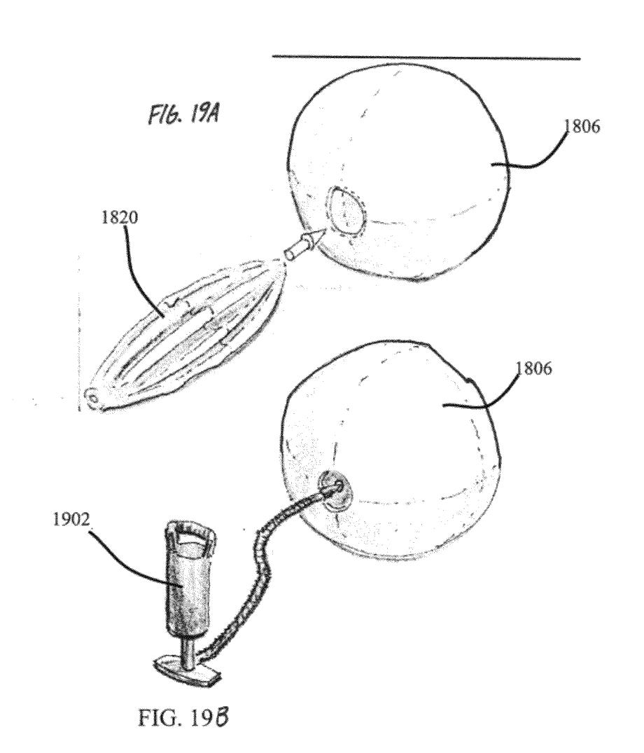

FIGS. 19A-B illustrate one method of providing a ball within a fabric cover. As shown, a ball cover system is rigidified by inflating a bladder within the cover. The cover is made from a flexible material like woven netting, woven fabric, or sheet plastic that surrounds the ball. A deflated ball 1820 is inserted through the opening in the ball cover 1806 with the inflation plug oriented to face the opening as shown in FIG. 19A, and then inflated by pumping up the ball to the proper inflation with a pump 1902 as shown in FIG. 19B. Although it is not necessary, the ball best is inflated until there is significant pressure between the covering and ball, making a tight frictional fit between the two. Various types of connection systems, such as those previously mentioned, can be used to connect the covers 1806 of adjacent balls to each other at various points on their surfaces so that plural balls can be stacked and built into numerous different configurations and structures.

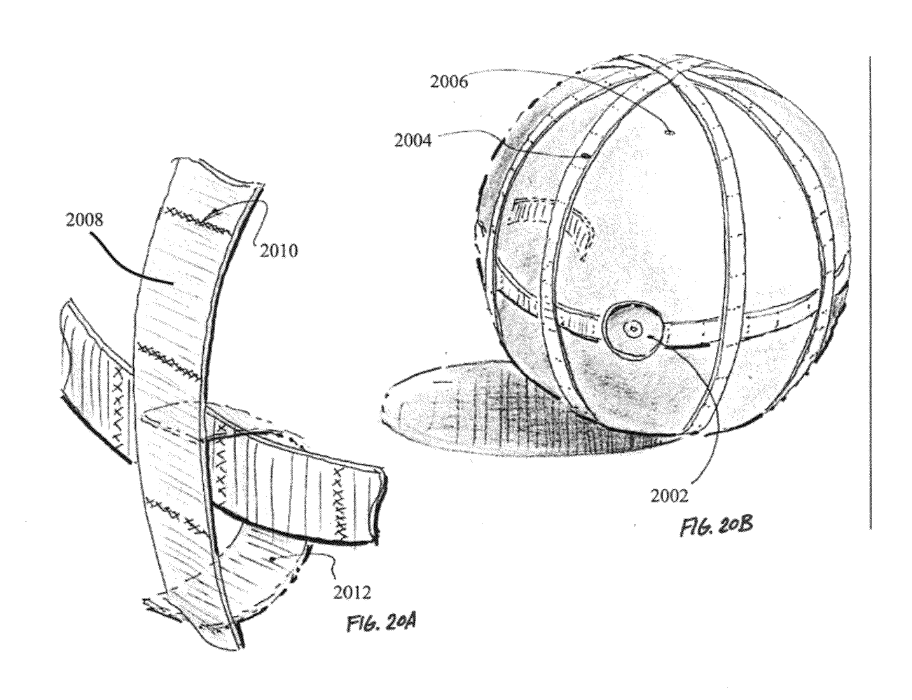

FIGS. 20A-B illustrate a strap harness system 2004 which is sewn directly on a ball cover 2006. The ball cover 2006 defines an opening 2002. Also shown is intermittent stitching 2010 of straps 2008 to create loops or connection locations 2012 for ball-to-ball connections. A ball-to-ball connection using loops 2012 is shown in FIGS. 20A.

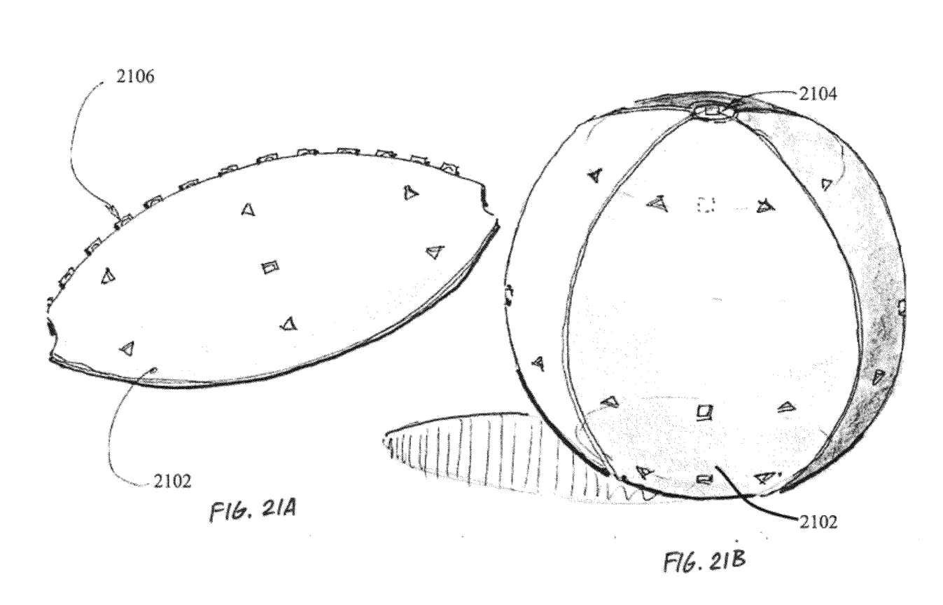

FIGS. 21A-B show a system for adding attachment points to a ball or bladder, such as an inflatable ball, by forming an enclosure around the ball. The illustrated enclosure has plural rigid, semi-rigid, or flexible segments 2102 which fit together using connections 2106 to define a generally spherical shape. An opening 2104 may be provided through the enclosure to allow access to a contained inflatable ball or bladder for the purpose of inflation and deflation. The enclosure segments best are made of flexible injection molded plastic.

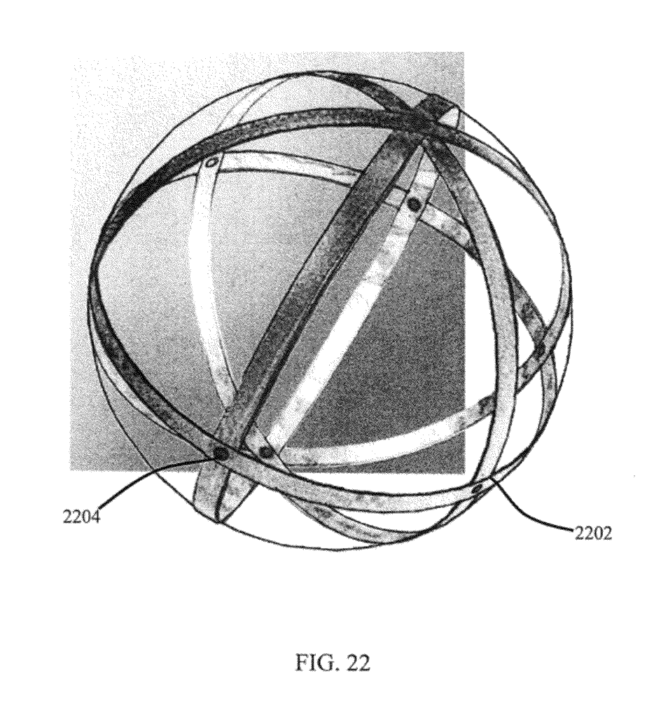

FIG. 22 illustrates the strap harness system 2202 in greater detail. Strap intersection points 2204 are shown. Although not necessary, it is best that the ball, when inflated, causes significant pressure between most of the harness and the ball, making for a tight frictional fit between the two. The number of straps can be varied depending on the number of connection points desired. The greater the number of connection points, the greater the number of structures that can be built by allowing for more variation in how balls can be positioned or configured relative to each other and then connected together so as to hold that position. The straps are used in combination with one or more connecting mechanisms such as a strap with a buckle, a snap, a plastic/metal clip, and any of a multitude of other connecting mechanisms. In this way ball members can be connected to each other in many different positions.

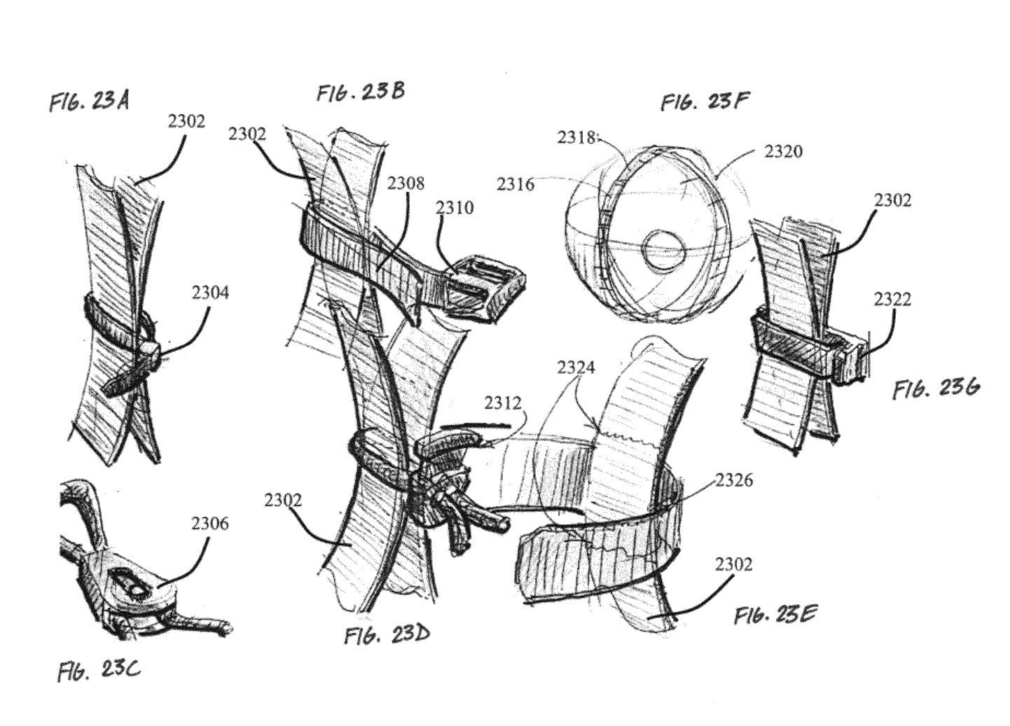

FIGS. 23A-G illustrate details of several strap harness system connections. FIG. 23A shows cable tie device 2304 which is shown binding together straps 2302. FIG. 23B shows webbing 2308 and a webbing adjustment buckle 2310 which bind together straps 2302. FIG. 23C and FIG. 23D show cord locks 2306, 2312 which may also be used to bind straps together. FIG. 23E shows a webbing loop 2326 that is constructed with stitches 2324 and that is used to bind together straps 2302. The loops 2316 and straps 2318 may be sewn or otherwise mounted onto a ball cover 2320 as shown in FIG. 23F. FIG. 23G shows a flat cable clamp 2322 binding together straps 2302.

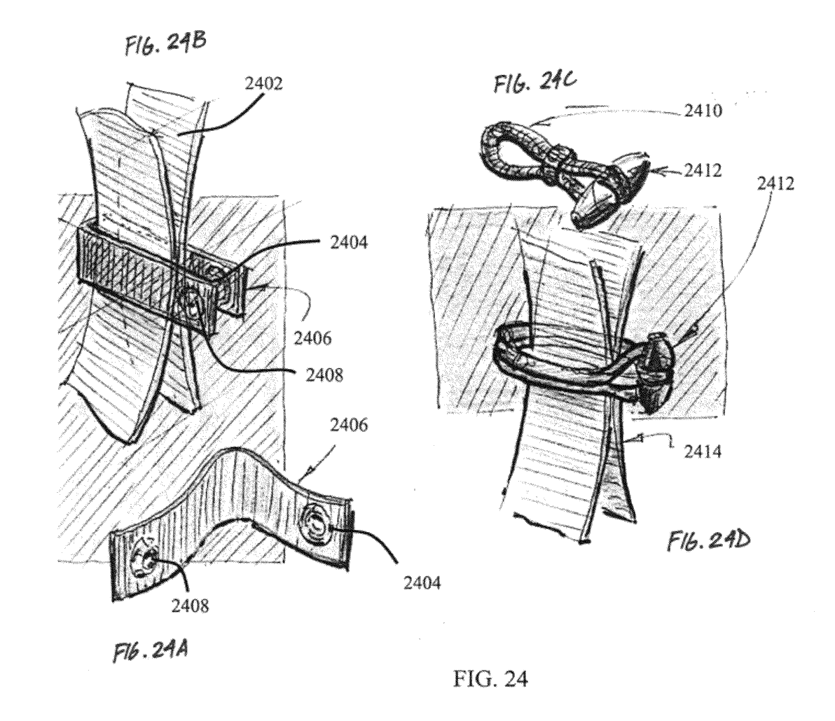

FIGS. 24A-D show details of two strap harness system connections for binding together the straps. The first system, illustrated in FIGS. 24A-B, is a strap device 2406 having a snap fastener 2402 including a male side 2408 and a spaced apart female side 2404 which can be snapped together to secure the strap 2406 around harness straps of two adjacent balls. The second system, illustrated in FIGS. 24C-D, has an elastic tie with a loop 2410 and a spaced apart “knob” 2412. The knob 2412 is brought through the loop 2410 in order to secure the tie around straps 2414.

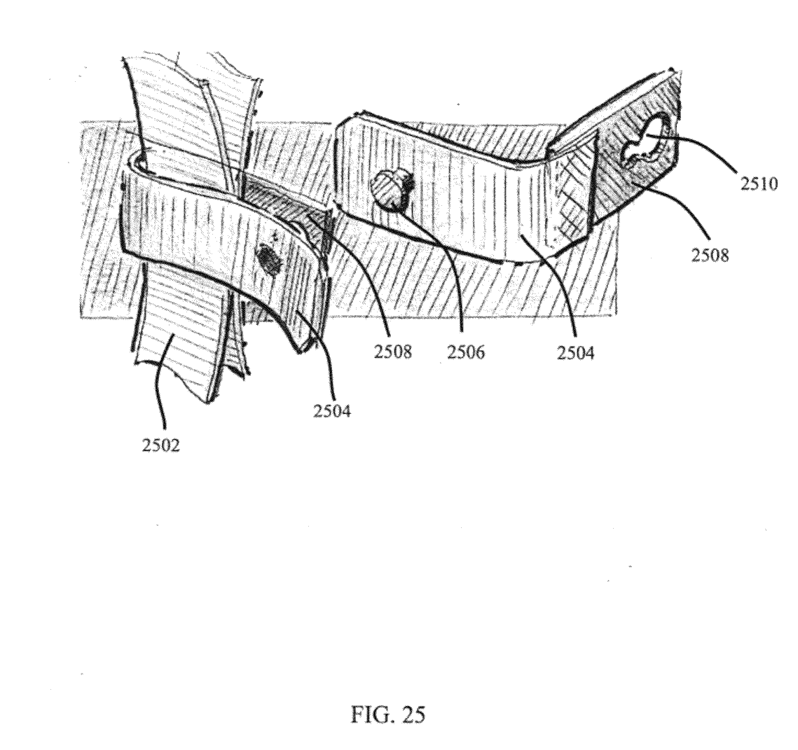

FIG. 25 illustrates a strap harness system connection utilizing an elastic strap 2504 with a button 2506 which is sewn, bonded, or heat staked to a second rigid plastic piece 2508. The button mates with a keyhole receptacle 2510 defined in a rigid plastic piece 2508 to bind together straps 2502.

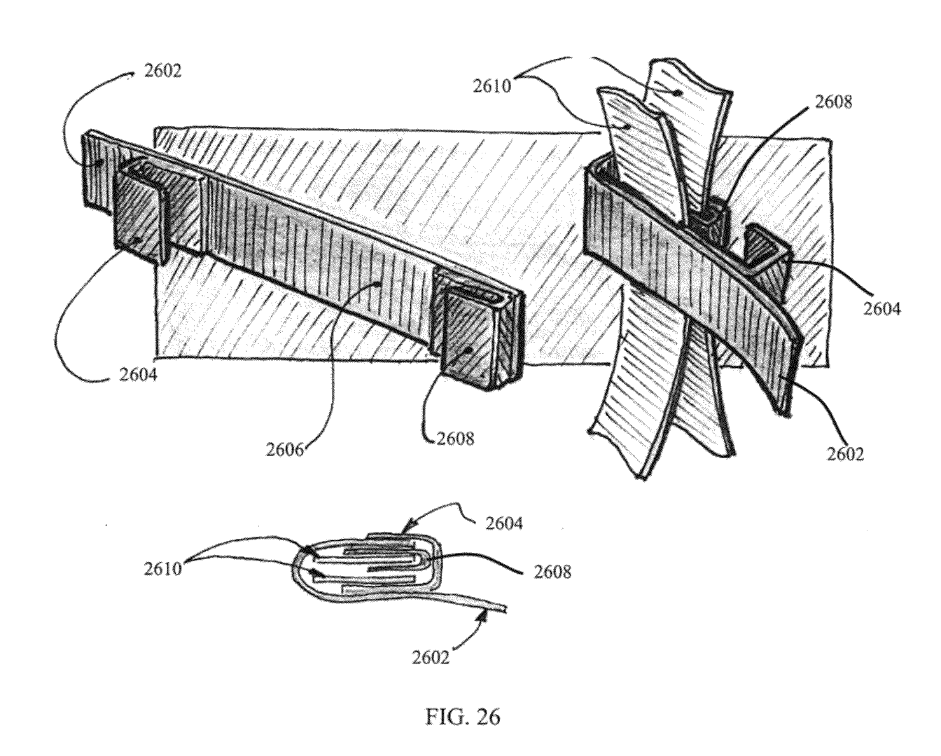

FIGS. 26A-C show a strap harness system connection having an elastic strap 2606 with a small hook 2608 at one end and a larger hook 2604 and pull tab 2602 at the other end. The connector wraps around so that the large hook 2604 locks around the small hook 2608 and two sections of harnesses strap of adjacent ball members. The connector is removed by pulling on the pull tab 2602.

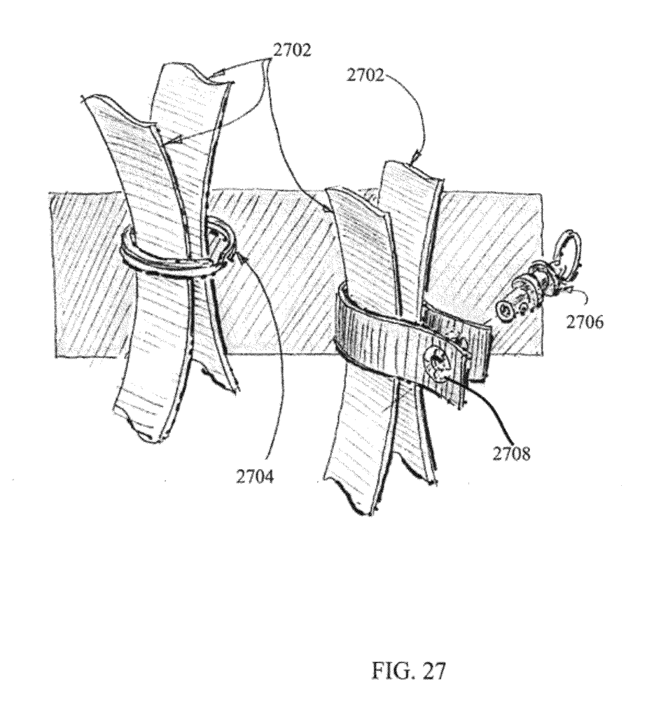

FIG. 27A illustrates a strap harness system connector that is a “key ring” 2704, which slides onto and off of the two adjacent strap harness sections 2702 when the key ring is rotated.

FIG. 27B illustrates a connector that is a strap with a grommet 2708 at each end. The grommets are held together with a quick release pin 2706 to forming a loop of strapping around two adjacent strap harness sections 2702.

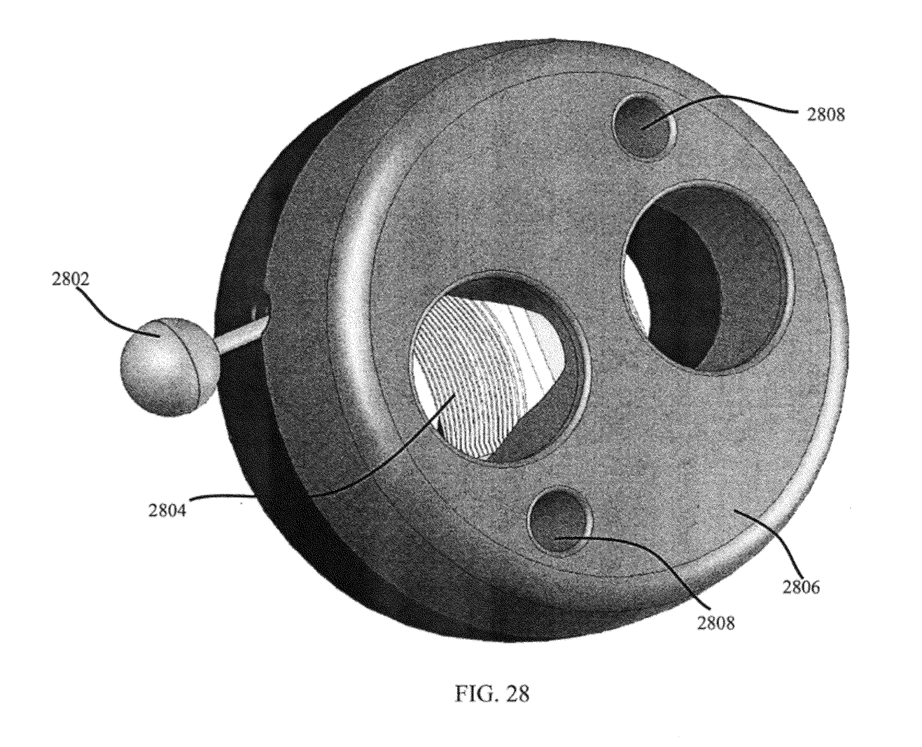

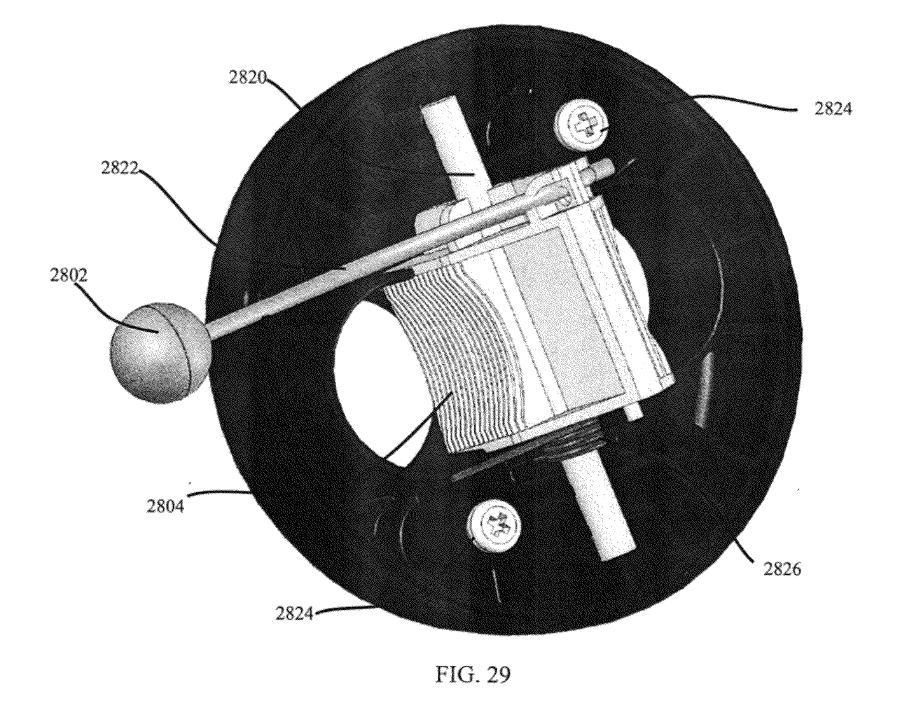

FIGS. 28-29 show a connector that can be used in place of the cam lock connector shown in FIG. 19. A single lever 2822 with knob 2802 moves a spring-loaded cam 2804, releasing a friction lock. This releases the external solid molded rods which attached to balls and allows them to be removed. In this connector the cam system either grips or releases both of the rods, and does not act on one independently of the other. FIG. 29 shows the same connector device with one half of the body 2806 removed to show detail of the cam 2804 and the torsion spring 2826. The body 2806 is held together with screws 2824, inserted into recesses 2808. Although a preferred embodiment is shown, other embodiments may include a variety of different cam and spring designs to achieve the same functionality.

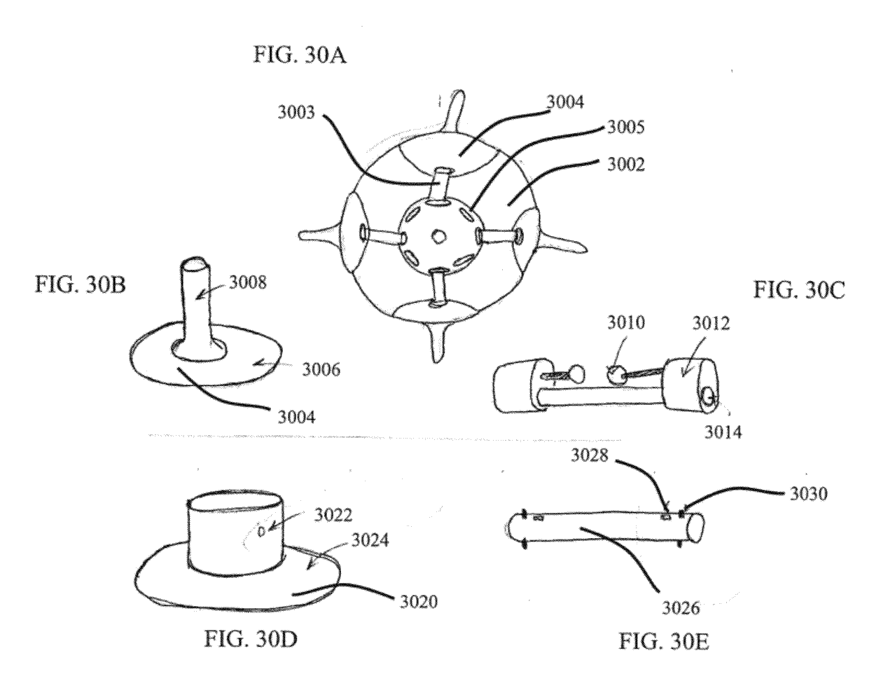

FIGS. 30A-E show a connector system which uses ordinary inflated members and connector bases that are secured together around a ball with straps. Two different types of connector bases are shown. FIG. 30A illustrates the first type with solid molded rods as installed on a ball 3002. As shown, six connector bases in total are installed on the ball. Four connector bases are arranged about the equator of the ball, and one connector base is located at each pole. The bases are secured around the ball using straps, such as strap 3003, such that the ball is encaged within a harness provided by the straps and connector bases. The straps may be of adjustable length to allow the whole assembly to be tightened around the ball; or the straps may be of fixed length and the ball inflated within the harness until the ball seats tightly. Unoccupied openings 3005 in the bases shown in FIG. 30A may be used for attaching straps and bases in addition to those shown. FIG. 30B shows a detail of the first type of connector base 3004 that has external solid molded rods 3008 protruding from mount 3006. Rods 3008 of adjacent ball members can be connected by a connector tube of the type shown in FIG. 30C. As shown in FIG. 30C, the connector tube has cam-type connectors 3012 such as one of those previously described with regard to FIGS. 17, 28, and 29. Such connectors have sockets 3014 which receive the solid molded rods 3008. FIG. 30D shows a second type of connector base 3024 that has a socket protrusion 3022 protruding from a mount 3024. The socket protrusion 3022 defines an outwardly facing receptacle that has an inner diameter greater than the outer diameter of connector tube 3026 as shown in FIG. 30E, such that the receptacle is sized to receive an end portion of the connector tube. Two connector bases 3024 respectively on adjacent ball members may be joined by a connector tube 3026. As shown in FIG. 30E, each end of connector tube 3026 has a latch locking feature including a detent 3030 and a release button 3028. The latch feature may be spring-loaded for ease of operation. For example, a spring may be provided such that application of pressure on the release button 3028 causes one or more detents 3030 to retract, and the spring causes the one or more detents to extend when the pressure on the button is removed.

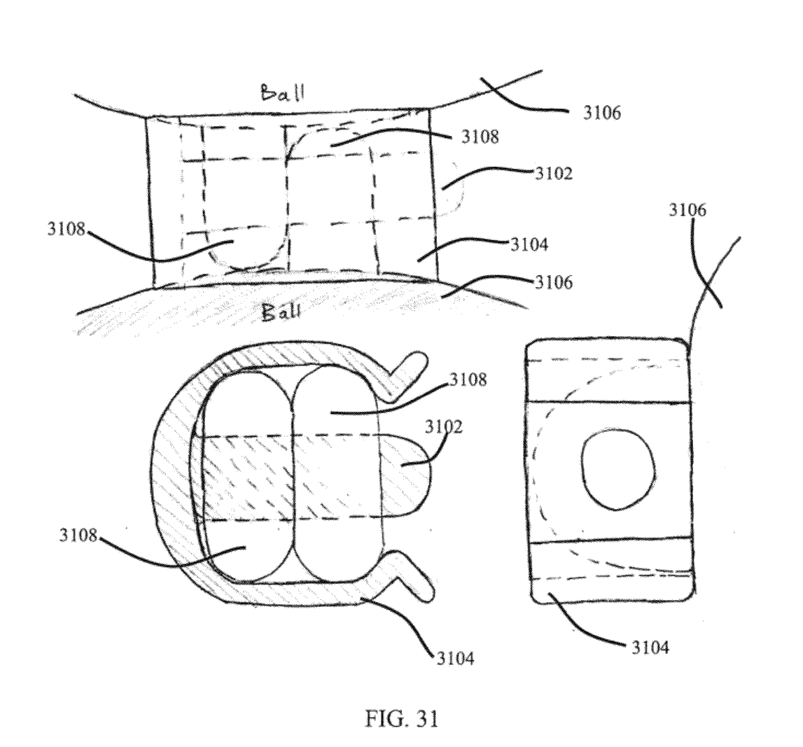

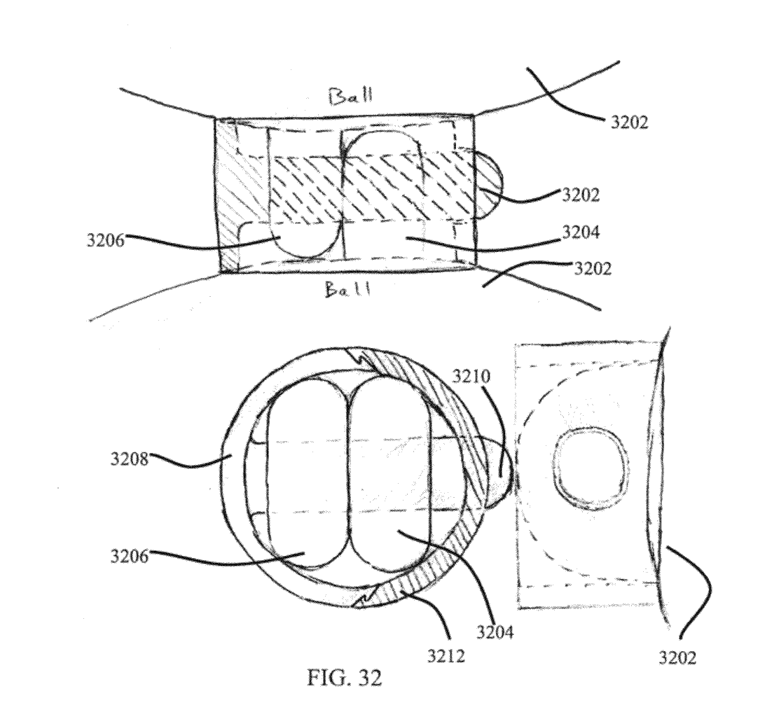

FIGS. 31A-C and FIGS. 32 A-C show two different types of connectors to be used with construction members having loop features 3108 at each of the connection points. Particularly illustrated are inflated ball members having loops molded onto their surfaces.

FIGS. 31A-C show the loop features 3108 of the two adjacent balls 3106 aligned. A single piece connector 3104 has a protrusion 3102 and two arms. The connector 3104 is attached by inserting the protrusion 3012 through the holes of both loops and with the arms snapped into a position where they embrace the loops.

In the system of FIGS. 32A-C, a two piece connector is used. A first piece 3208 has a protrusion 3210 and two arms. The first piece 3208 is placed so that protrusion 3210 passes through the holes of each of the loop features 3204, 3206 on adjacent balls 3202. A second piece 3212 is shaped and sized to mate with the first piece so that the first and second pieces together encircle the loop features 3204, 3206. In the illustrated system, the second piece 3212 has two hooks that are spaced to engage with corresponding hooks on the arms of the first piece 3208. The second piece 3212 thus is added to the first piece after the protrusion is inserted to lock the ball members together. By squeezing the arms of the first piece 3208, the two pieces 3208, 3212 are able to be unlocked and separated so that the first piece can be removed to release the ball members.

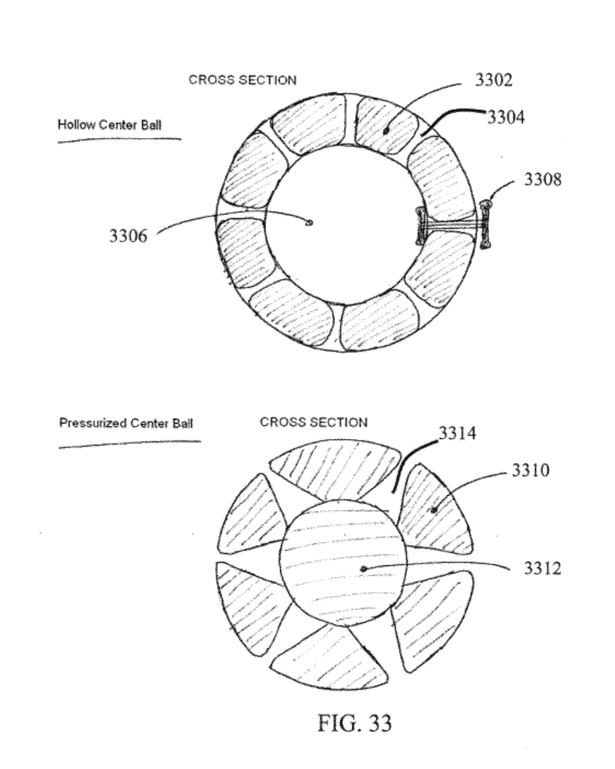

FIGS. 33A-B illustrate two connection systems of multi-chambered inflated members. FIG. 33A shows a hollow-centered ball 3302 which has a central chamber or core 3306 which is open to the ambient atmosphere through multiple round openings 3304 defined by generally cylindrical walls which extend through its exterior. A connector device 3308 which resembles a double “T” is used to attach to adjacent balls. FIG. 33B shows a connection system consists of a pressurized inner ball 3312 and protruding pressurized segments 3310 which are spaced to define cavities 3314 into which a double “T” type connector can be inserted.

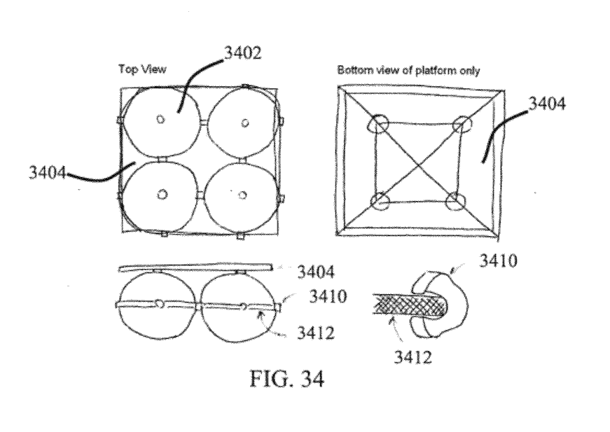

FIG. 34A-D show another technique for construction with multiple balls. Encompassing perimeter bands 3412 extend around a layer of balls 3402 to increase the structural integrity of a structure. The bands 3412 are secured to the balls 3402 at attachment points 3410. A rigid platform member 3404 is used to provide a solid surface on top of the layer of balls.

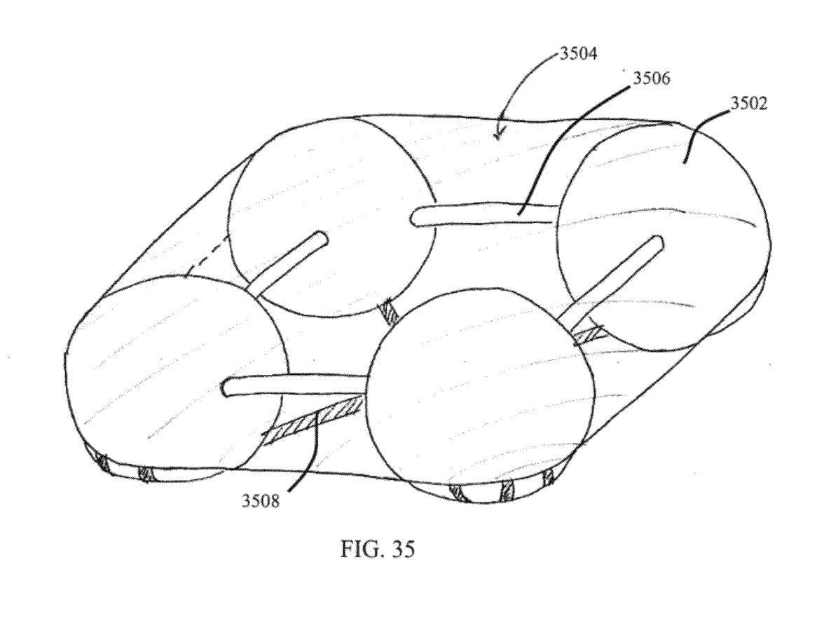

FIG. 35 shows a structure formed with multiple balls 3502 and hollow construction elements 3506. An upper surface 3504 is formed with an encompassing platform cover and is secured below with reinforcing straps 3508. Suitable materials for such a cover would include a mesh of webbing or a woven fabric.

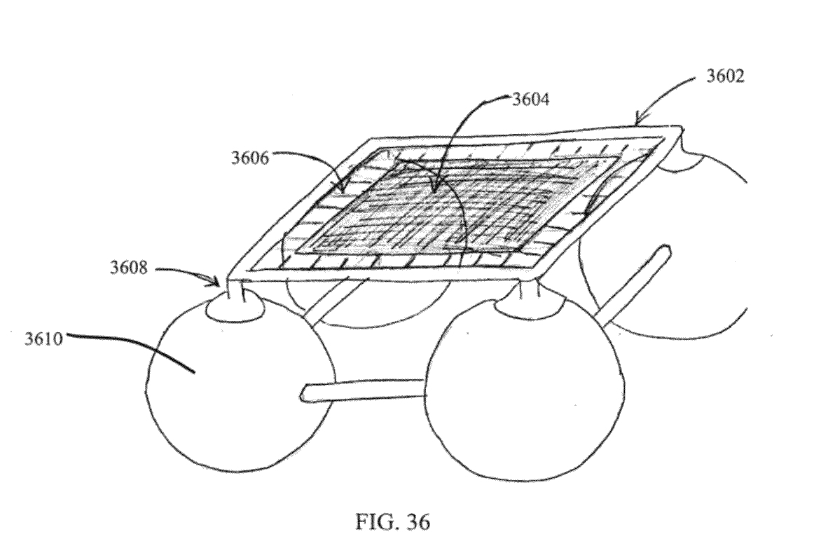

FIG. 36 shows a constructions for supporting either square or round trampolines 3602 on structure made of inflated balls 3610 and hollow construction elements.

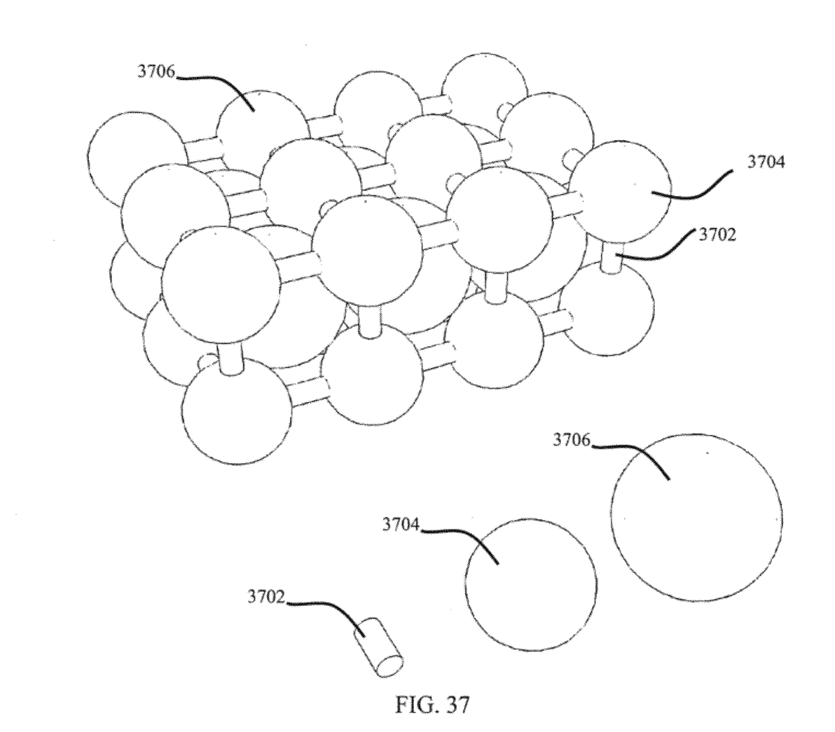

FIG. 37A illustrates a system composed of two sizes of inflated balls and rigid or semi-rigid cylindrical connectors. Each of these elements is shown separately in FIGS. 37B-D. In alternative arrangements, the smaller of the balls may be composed of flexible foam rubber, and the connection points may be strengthened through the use of in-molded ropes, links, or other support structure. The smaller of the two ball sizes is selected so that it fits in the space between the larger sized balls when arranged in a three dimensional array. As shown in FIG. 37A, depending on their particular locations, these smaller balls may tangentially contact as many as eight of the larger balls simultaneously. In a preferred embodiment, the ratio of diameters of the smaller of the balls to the larger of the balls is about 1:1.37.

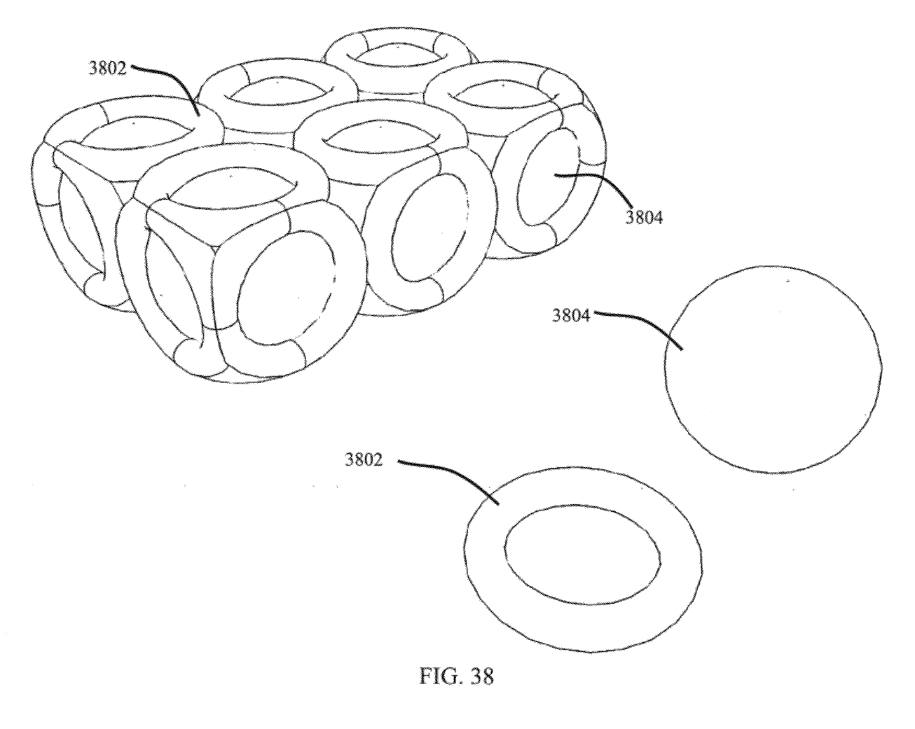

FIG. 38A illustrates a system of hollow construction members using inflatable balls 3804 and inflatable toroidal members 3802 which are connected using straps. Each of these inflatable elements is shown separately in FIGS. 38B-C. The straps are looped around the points where the inflatable toroidal members touch, and are drawn tight in order to secure the assembly. The toroidal members usefully are sized appropriately for the diameter of the balls such the toroidal members generally fit within the interstices between the balls of an array.

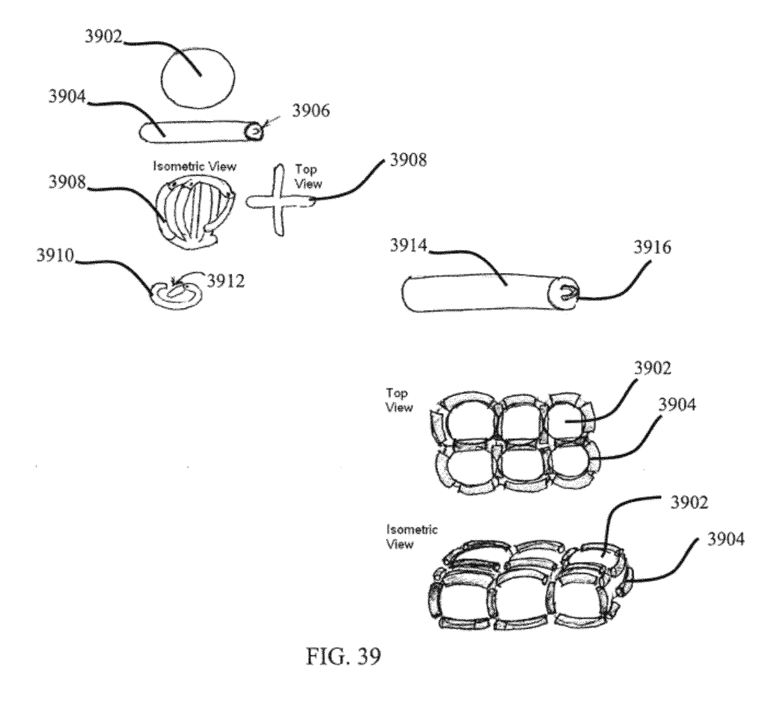

FIGS. 39A-H show a structure formed from arrays of inflated balls and inflated tubular members that are connected using “carabiner” style gated connectors. The diameters of the tubular members usefully are sized appropriately for the diameter of the balls so that the tubular members fit within the interstices between the balls of an array. An appropriate ratio of the diameter of the inflated balls to the diameter of the inflated tubular members is about 1:2.41.

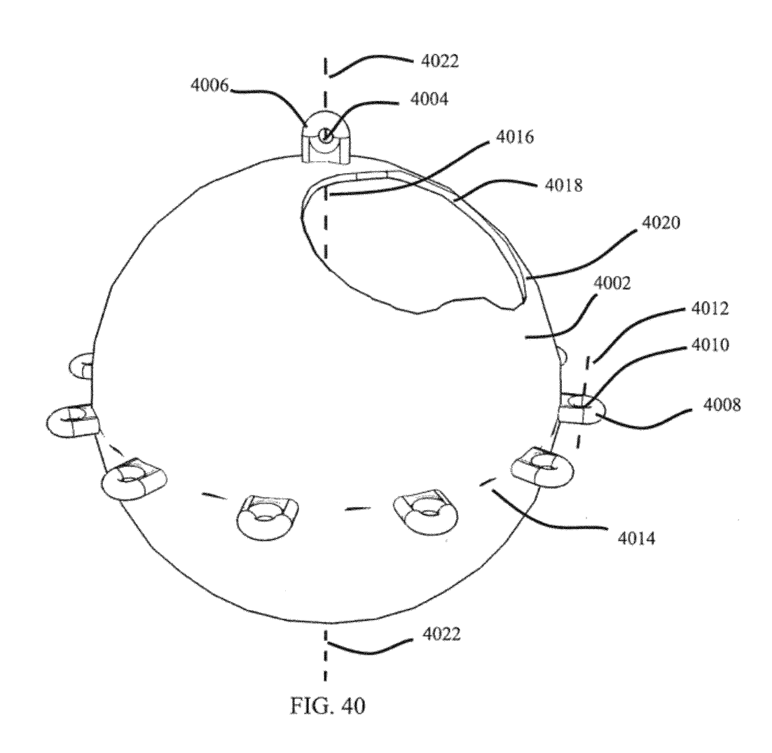

FIG. 40 illustrates an advantageous inflatable ball. This ball utilizes a specific connection type and arrangement of connection points to optimize both the utility of the ball in construction of ball assemblies, as well as the manufacturability of the ball. The ball 4002 is inflatable, and it size is generally between 6 inches and 30 inches in diameter. The ball 4002 best is manufactured using a rotomolding process. Advantages of this manufacturing process are that a consistent wall thickness can be achieved, and that it is a relatively inexpensive. The ball 4002 has a wall 4018 with an outer surface 4020. Numerous connection points are provided on the surface 4020 around the equator 4014 of the ball. The ball 4002 also has a connection point located at each pole. In the illustrated ball, a ball centerline or vertical axis 4016 extends through the poles 4022. Located at each equatorial connection point is a protruding loop 4008 that defines a passageway or eye 4010 having a connector centerline or axis 4012 that extends generally parallel to the vertical axis 4016 of the ball. Located at each polar connection point is a protruding loop 4004 that defines a passageway or eye 4006 having a connector centerline or axis that extends generally perpendicular to the vertical axis of the ball. The two polar connector axes advantageously extend generally parallel to each other such that the passageways or eyes have the same general orientation. The illustrated ball advantageously has a total of twelve connection points 4008 at locations spaced around a circle that is the equator 4014 of the ball, with the locations on radials each separated by about thirty degrees. This arrangement provides for optimal utility in connection of the balls into structures. The passageways 4006 and 4010 advantageously have an inner diameter that is generally between 0.1 inches and 1.0 inches. FIG. 40 shows protruding loop connectors having passageways that are circular in cross-section. It should be appreciated that such passageways may have another cross-sectional shape, such as a rectangular, triangular, square, pentagonal, hexagonal or octagonal. Although the outer surface of the ball shown in FIG. 40 is generally spherical, inflatable members having outer surfaces of other shapes, including but not limited to cylinders or toroids, may advantageously employ protruding loop connectors.

The ball shown in FIG. 40 may be manufactured by a rotomolding process in a mold with two parts. The parting line of the mold is aligned with the equator of the ball and the midpoint of the connecting features arranged on the equator. The mold also has features corresponding to the connection points 4004 at each pole of the ball. Each of these features contains the recess within which is formed the outer portion of the connection point, and removable pins on which are formed the walls of the eyes 4006 of the polar connection points. The pins are inserted prior to beginning the rotomolding process. At the conclusion of the rotomolding cycle, the pins at each pole are removed from the mold. Because of the orientation of the eye features of the connections along the equator, the completed part may then be easily removed from the mold once the two halves of the mold are separated.

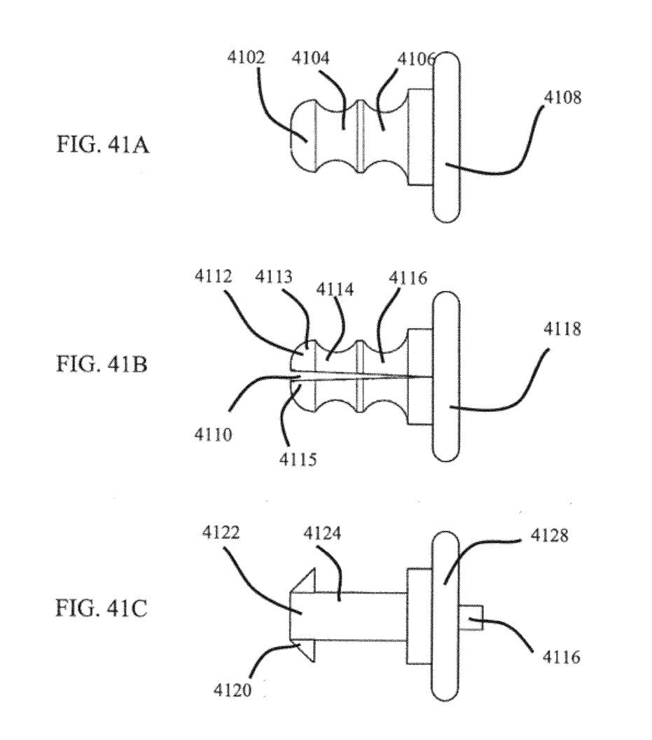

FIGS. 41A-C illustrate various connectors which may be used to join the connection points 4008 of two balls 4002 of the type shown in FIG. 40. FIG. 41A shows a connector 4102 having a shaft 4102 with a handle 4108 at one end. Prior to use, two balls 4002 are brought together such that the side of a connector 4008 of one ball abuts the side of a connector 4008 of another ball, and such that the center of each eye is aligned. A user pushes against the handle 4108 in order to insert the free end of the connector through both eyes to join the balls, and subsequently can pull on the handle to remove the connector when desired. The free end of the shaft 4102 is rounded or tapered to allow for easier insertion through the eye 4010 of each ball. Circular grooves 4104, 4106 are provided on the surface of the shaft 4102 and are sized, shaped, and spaced such that each accepts and nests the inner wall of the eye of one of the balls. The connector 4102 is held in place by frictional contact between the connector the walls that define the ball eyes. Due to the flexible nature of the ball material, the walls that define the ball eyes flex and expand to allow the connector 4102 to be inserted and removed when sufficient force is applied to the connector parallel to the centerline of the shaft.

FIG. 41B shows a connector 4112 that is similar to the connector 4102 shown in FIG. 41A, with the addition of a split 4110. The connector 4112 has a handle 4118 and a shaft with a rounded end and grooves 4114, 4116. The split 4110 allows half shaft 4113 and half shaft 4115 to flex together as the connector is inserted. This serves the purpose of reducing the flexing of the ball eye features during insertion as well as reducing the force required for insertion.

FIG. 41C shows a connector 4122 that is used to join two balls 4002 similarly to the connectors shown in FIGS. 41A-41B. This connector has a shaft 4124 with a retaining feature, such as dogs 4120, and a stop, such as a handle 4128 with button 4116, at spaced-apart locations, in particular at or near each end of the shaft respectively. The connector is inserted, leading with the end of the shaft having retaining feature 4120, through the eyes of two balls, by pressing on handle 4128. The retaining feature is spring loaded so that the dogs 4120 retract into the shaft 4124 when passing through the ball eyes. After passing through the eyes, the spring (not shown) causes the dogs 4120 extend to lock the balls together. In order to remove the connector 4122, the user depresses the button 4116 to retract the dogs 4120 and pulls on the handle 4128.

As shown in FIG. 41A-C, the connectors are based upon a round cross-sectional profile, but, in alternate embodiments of the invention, the shaft may be any shape which mates with the corresponding eye feature of the ball. This may include but is not limited to a rectangle, triangle, square, pentagon, hexagon or octagon. The combination of these non-round cross sectional profiles with a corresponding ball eye would produce a connection which could not be rotated.

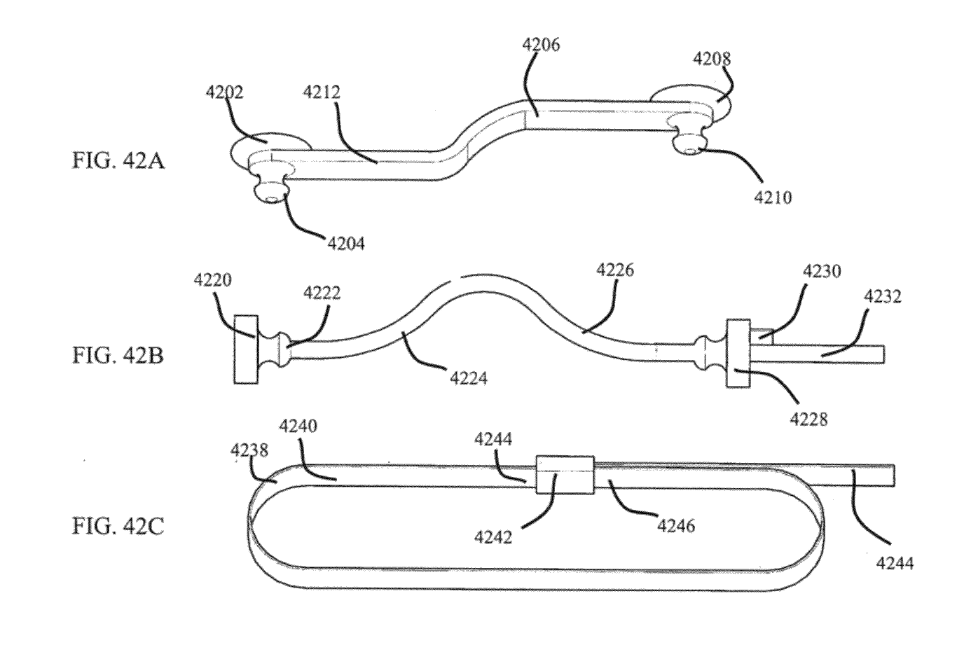

FIGS. 42A-C illustrate various flexible elongated connectors. The purpose of the flexible elongated connectors is to link two loop connectors which cannot be brought together in the proximity and orientation required with the connectors described in FIGS. 41A-C. The these flexible elongated connectors may be composed of inelastic material such as rope, cord, wire, or webbing, or elastic material such as rubber, latex, or bungee cord. A connector with an inelastic link would maintain a constant distance between connection points and would be suitable when building a structure with limited movement of the balls. A connector with an elastic link would allow the distance between the connection points to increase when stretched, and so could be used to create a very loose and dynamic structure of balls. These connectors may be used to join two balls at the connection points which are in closest proximity. In addition, they may be used to join an assembly of balls together around an outer perimeter. One application of this is to hold a layer of balls together in compression, so as to counteract horizontal forces applied to the balls which may cause them to otherwise spread outward. As will be shown, such connectors may be of fixed length or may be mechanically adjustable in length. A single mechanically adjustable-length connector, such as one of those shown in FIGS. 42B-C, may be used to connect the outer perimeter connection points of a multitude of balls simultaneously. The range of lengths used typically varies between 4 inches and 240 inches.

FIG. 42A shows a connector 4212 with a fixed-length elastic or inelastic link 4206. Located at two spaced-apart locations along the link are two connectors. In particular, FIG. 42A shows a connector having a handle 4202 and a nipple 4204 at one end of the link 4206 and a connector having a handle 4208 and a nipple 4210 at the other end of the link. Each nipple 4204, 4210 is inserted through the eye of a loop on one of two different balls which the user wishes to join. A circular groove is provided on the surface of each nipple 4204, 4210 and is sized and shaped such that each accepts and nests the inner wall of the eye of one of the balls.

FIG. 42B shows a flexible elongated connector 4224 with an elastic or inelastic link 4226. Connector 4224 is mechanically adjustable in length, having two parts that can be moved relative to each other. At one location, at the end of the link shown in FIG. 42B, is a fixed stop 4220. Stop 4220 may or may not include a surface portion with a retainer ring 4222 and/or a groove which interfaces with the wall of a ball eye when attached to a ball. At a spaced-apart location on the link 4226 is a movable stop 4220. The movable stop 4220 has an internal locking mechanism, which may include but is not limited to a locking cam or roller binding lock or a ratchet mechanism. Tab 4230 is used to release the locking mechanism when the user desires to change the distance between the stops. The connector 4224 may be used to connect balls at two or more ball connection points. It is installed by removing the movable stop 4220, and then routing the free end 4232 of the link through the eyes at the desired ball connection points. Once that is completed, the movable stop 4230 is placed over the free end 4232 and then pulled along the link toward the fixed stop 4220. The user may continue to pull on the movable stop 4230 in order to obtain the desired distance between the fixed stop 4220 and movable stop, which determines the distance between the selected ball connection points.

FIG. 42C shows a flexible elongated connector 4238. The flexible link 4240 is secured at an end 4246 to a buckle 4242. Flexible link 4240 is shown as also extending through the buckle 4242 at a location 4244 so that one portion of the flexible link is in the form of a loop and another portion of the flexible link extends from the buckle terminating at a free end 4244. Buckle 4242 has an internal locking mechanism, which may include but is not limited to a locking cam or roller binding lock. The connector 4240 may be used to connect balls at two or more ball connection points. The connector 4240 is installed by first pulling the extending portion of the link, including the free end 4244, out of the buckle. The free end 4244 then is routed through the desired ball connection eyes. Once that is completed, the free end 4244 is then reinserted into buckle 4242 and pulled through, forming a circuit which connects the balls at all of the selected ball connection points. The user may continue to pull the free end 4244 in order to obtain the desired circuit size, which determines the distance between the selected ball connection points.

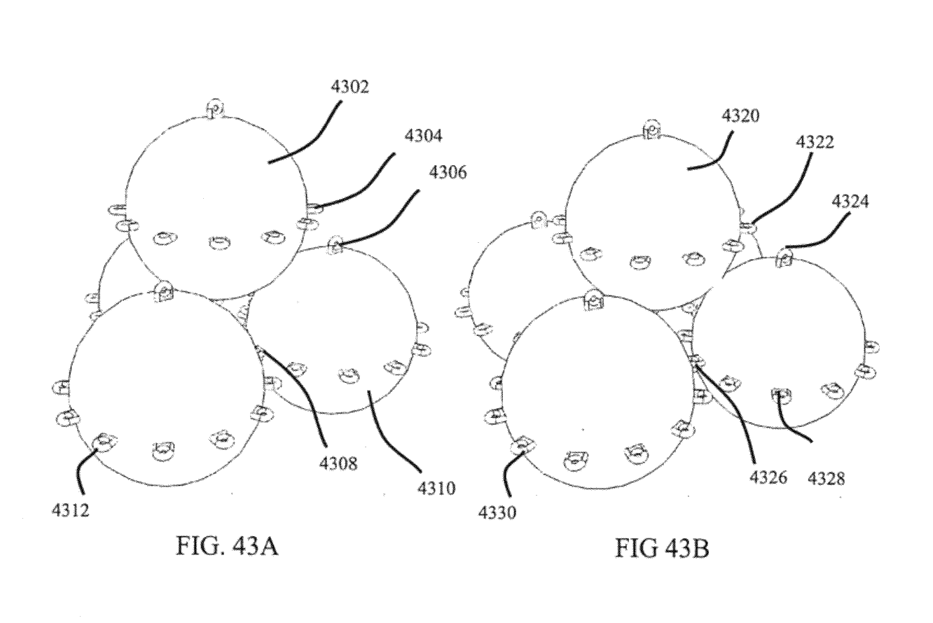

FIGS. 43A-B illustrate constructions of inflatable balls having two different geometric arrangements. FIG. 43A shows a construction using hexagonal close-packed structure. This arrangement consists of a base layer of three balls 4310, with one ball 4302 centered on the top layer. The base layer balls 4310 are arranged so that they are each contacting tangentially at two points about their respective equators. They are also arranged such that their connection points 4312 are aligned at each of these contacts with the centers of their adjacent eyes aligned. In this manner, they may be joined at contact points 4308 using a connector of the types shown in FIG. 41A-C. The balls 4310 of the base layer may also be joined to the ball of the top layer 4302 using a flexible connector of the types illustrated in FIG. 42A-C. The connector would be attached at the connection point 4304 of the upper ball and at the connection point 4306 of the lower ball.

FIG. 43B illustrates a construction using body centered cubic structure. This arrangement consists of a base layer of four balls 4328, with one ball 4320 centered on the top layer. The base layer balls 4328 are arranged so that they are each contacting tangentially at two points about their respective equators. They are also arranged such that their connection points 4330 are aligned at each of these contacts with the centers of their eyes aligned. In this manner, they may be joined at contact points 4326 using a connector of the types shown in FIG. 41A-C. The balls 4328 of the base layer may also be joined to the ball of the top layer 4320 using a flexible connector of the types illustrated in FIG. 42A-C. The connector would be attached at the connection point 4322 of the upper ball and at the connection point 4324 of the lower ball.

In view of the many possible arrangements to which the principles of the disclosed invention may be applied, it should be recognized that the illustrated arrangements are only preferred examples and should not be taken as limiting the scope of the invention. Rather, the scope of the invention is defined by the following claims.

1. A climbing structure capable of supporting plural resilient inflatable or water fill-able air or water tight hollow members that are coupled together and that together form a self-supporting structure.

2. A structure of according to claim 1 wherein at least some of the members are generally spherical.

3. A structure of according to claim 1 wherein at least some of the members are made of rotomolded thermoplastic material.

4. (canceled)

5. A structure according to claim 1 wherein at least some of the members are arranged such that at least a portion of the structure has the shape of a building that defines an interior region that is hollow and of sufficient size to receive a person.

6. (canceled)

7. A structure according to claim 1 wherein at least some of the members are arranged to form interlocking polygons and such that at least a portion of the structure has the shape of a dome.

8. A structure according to claim 1 wherein:
at least some of the members are arranged to provide a perimeter wall structure; and
the structure further comprised an expanse of waterproof material that extends to the perimeter wall structure and that is shaped to form a basin to receive and hold a body of water.

9.-21. (canceled)

22. A structure according to claim 1 wherein all of the members are of the same size and shape.

23. A structure according to claim 1 wherein:
at least some of the members are of a first size; and
at least some of the members are of a second size that is different than the first size.

24. A structure according to claim 1 wherein at least some of the members are arranged in a lattice having a pattern selected from the group consisting of simple cubic, body-centered cubic, face-centered cubic, triclinic, simple monoclinic, base-centered monoclinic, simple orthorhombic, base-centered orthorhombic, body-centered orthorhombic, face centered orthorhombic, hexagonal, rhombohedral, simple tetragonal, and body-centered tetragonal.

25.-28. (canceled)

29. A coupling system for joining two construction members together, the system comprising:
a first hollow construction member having a protrusion; and
a second hollow construction member having a connector for securing the protrusion to the second hollow construction member, the connector comprising a wall that at least partially defines an opening that is positioned and sized to receive the projection and a cam member positioned opposite the wall to prevent the projection from pulling out of the opening when the projection is located between the wall and the cam member.

30.-34. (canceled)

35. A construction system comprising:
a connector element;
a first hollow construction member having a socket sized and shaped to receive and connect to a portion of the connecter element; and
a second hollow construction member having a socket sized and shaped to receive and connect a portion of the connecter element.

36.-40. (canceled)

41. The construction system according to claim 35, comprising:
at least one harness containing at least one of the construction members; and at least one fastener element on each harness.

42. The construction system according to claim 35, comprising:
plural modeling members that are proportionally smaller than corresponding ones of the construction members and that are capable of being coupled together to form a self-supporting structure that is a reduced scale model of a full-sized structure capable of being built from the construction members.

43.-46. (canceled)

47. The construction system of claim 29, wherein at least one of the construction members comprises:
plural loop connectors at spaced-apart locations on the an outer surface thereof.

48.-50. (canceled)

51. A structure according to claim 1 wherein:
each of at least two of the plural hollow members has a wall that has an outer surface with plural eyes extending outwardly from the outer surface at spaced-apart locations on the outer surface; and
the structure comprises a connector attached to an eye of each of the at least two hollow members such that the at least two hollow members are joined together.

52. A structure according to claim 51 wherein:
the outer surface of each of the at least two of the plural hollow members is generally spherical; and
plural eyes are spaced around a circle that is at the equator of the surface.

53. A structure according to claim 52 wherein the hollow member further comprises an eye at a pole of the surface.

54. A structure according to claim 52 wherein twelve eyes are spaced around the circle that is at the equator of the surface with the distances between successive eyes being about equal, and one eye is located at each pole of the surface.

55. A structure according to claim 51 wherein the connector is a plug-type connector inserted through openings of two adjacent eyes of two hollow members to be joined together.

56. A structure according to claim 55 wherein the plug-type connector has a retaining feature acting as a protrusion preventing the connector from sliding out of the eyes.

57. A structure according to claim 56 wherein the retaining feature is spring-loaded having a button to retract the retaining feature.

58. A structure according to claim 51 wherein the connector is a flexible elongated connector.

59. A structure according to claim 58 wherein the flexible elongated connector has spaced-apart plug-type connection points.

60. A structure according to claim 58 wherein the elongated connector is adjustable in length.

61. A structure according to claim 60 wherein the elongated connector has:
a link routed through the eyes of the at least two joined hollow members; and
a movable stop connected to a routing free end of the link.

62. A structure according to claim 61 wherein:
the link has a fixed stop at one end; and
the movable stop is movable along the link for obtaining a desired length between the fixed stop and the movable stop.

63. A structure according to claim 61 wherein the movable stop has:
an internal locking mechanism; and
a tab for releasing the locking mechanism.

64. A climbing structure according to claim 1 comprising plural resilient inflatable or water fill-able air or water tight hollow members that may be coupled together and that together form a self-supporting structure able to support one or more persons climbing on said structure.
